(19) United States
(12) Patent Application Publication
(10) Pub. No.: US 2015/0277958 A1
(43) Pub. Date: Oct. 1, 2015

(54) MANAGEMENT DEVICE, INFORMATION PROCESSING SYSTEM, AND MANAGEMENT PROGRAM

(71) Applicant: FUJITSU LIMITED, Kawasaki-shi (JP)

(72) Inventor: Takashi Tanaka, Yokohama (JP)

(21) Appl. No.: 14/662,829

(22) Filed: Mar. 19, 2015

(30) Foreign Application Priority Data
Mar. 31, 2014 (JP) 2014-071196

(51) Int. Cl. G06F 9/455; H04L 12/26; H04L 29/08

(52) U.S. Cl. CPC G06F 9/45558; H04L 67/10; H04L 43/10; G06F 2009/45595

(57) ABSTRACT

A management device that manages an information processing device that creates a virtual machine, includes a storage unit that stores a first communication bandwidth in which the virtual machine is allowed to perform communication and a second communication bandwidth in which a port of a physical network device connected to the information processing device is allowed to perform communication, an instructing unit that instructs the information processing device to broadcast a measurement packet associated with the virtual machine, an acquisition unit that acquires communication history of the measurement packet in the port, and a determining unit that determines a use state of the physical network device, based on the communication history, the first communication bandwidth, and the second communication bandwidth.

### CROSS-REFERENCE TO RELATED APPLICATION

This application is based upon and claims the benefit of priority of the prior Japanese Patent Application No. 2014-071196, filed on Mar. 31, 2014, the entire contents of which are incorporated herein by reference.

### FIELD

The present invention relates to a management device, an information processing system, and a management program.

### BACKGROUND

In recent years, with improvement in the performance of physical machines (hereinafter also referred to as VM hosts), a virtualization technique of concentrating a plurality of virtual machines (hereinafter also referred to as VMs) on one physical machine has been studied. This virtualization technique enables virtualization software (hypervisor) to allocate a physical machine to a plurality of virtual machines to provide sectional views with the aid of application programs (hereinafter also referred to as applications) installed in the respective virtual machines. In recent years, data center service providers and the like (hereinafter also referred to as service providers) rent a virtual machine to users. The service providers rent the virtual machine to users based on conditions defined by a contract.

Here, the service provider needs to manage resources used by the virtual machine so that the virtual machine rented to users meets the conditions (for example, allowable communication bandwidths) defined by the contract. For example, the service provider monitors the state of a network including communication devices so that the network operates normally. When a failure occurs in the communication devices or the like, the service provider allows the virtual machine to migrate so as to secure a communication bandwidth in which the virtual machine can perform communication (for example, see Japanese Patent Application Publication No. 2012-094119 and Japanese Patent Application Publication No. 2013-171355).

### SUMMARY

For example, when a new virtual machine is created, it is necessary to secure a communication bandwidth to be used by the virtual machine in a physical machine in which the virtual machine is created. Due to this, the service provider monitors the number of virtual machines that can be created in each physical machine and the number of virtual machines that have been created in each physical machine. Moreover, the service provider creates a new virtual machine in a physical machine in which it is determined that the physical machine has sufficient resources.

However, it is difficult to predict exactly the communication path used after a new virtual machine is created. Due to this, even when a virtual machine is created in a physical machine which has sufficient resources, bottleneck may occur in a network (for example, a physical switch disposed outside the physical machine) due to the communication of the virtual machine. In this case, for example, when the network has a complex configuration, it may be difficult to specify the locations of bottleneck. Moreover, even after the locations of bottleneck are specified, it is necessary to takes measures such as performing migration in order to eliminate the bottleneck occurred.

Moreover, during normal system operation (even when a new virtual machine is not created), bottleneck may occur in the network depending on the use frequency or the like of the virtual machine by users.

According to an aspect of the embodiments, a management device that manages an information processing device that creates a virtual machine, includes a storage unit that stores a first communication bandwidth in which the virtual machine is allowed to perform communication and a second communication bandwidth in which a port of a physical network device connected to the information processing device is allowed to perform communication, an instructing unit that instructs the information processing device to broadcast a measurement packet associated with the virtual machine, an acquisition unit that acquires communication history of the measurement packet in the port, and a determining unit that determines a use state of the physical network device, based on the communication history, the first communication bandwidth, and the second communication bandwidth.

It is possible to predict the occurrence of bottleneck in a network.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an entire configuration of an information processing system.

FIG. 2 is a diagram illustrating a hardware configuration of a management server and a VM host.

FIG. 3 is a functional block diagram of the management server illustrated in FIG. 2.

FIG. 4 is a functional block diagram of the VM host and the physical switch illustrated in FIG. 2.

FIGS. 5 and 6 are diagrams for describing a general virtual machine and a general physical switch.

FIG. 7 is a sequence chart for describing an outline of a network management process according to the first embodiment.

FIG. 8 and FIGS. 9A and 9B are diagrams for describing an outline of a network management process according to the present embodiment.

FIGS. 10 and 11 are diagrams for describing the network management process executed by the management server.

FIG. 12 is a diagram for describing the network management process executed by the VM hosts 12A, 12B, and 12C.

FIG. 13 is a diagram for describing the network management process executed by the physical switches 15A, 15B, 15C, and 15D.

FIG. 14 is a diagram illustrating the relation between VM hosts 12A, 12B, and 12C, virtual machines 13A to 13E, and physical switches 15A to 15D.

FIG. 15A is an example of the virtual machine communication bandwidth information 133 in the example of FIG. 14.

FIG. 15B is an example of the physical switch communication bandwidth information 134 in the example of FIG. 14.

FIG. 16A is an example of the virtual machine communication bandwidth information 133 and the configuration information 136 in the example of FIG. 14.

FIG. 16B is an example of the MAC address information 135 in the example of FIG. 14.

FIGS. 17A and 17B are examples of the measurement instruction in the example of FIG. 14.

FIGS. 18A and 18B and FIGS. 19A and 19B are examples of the communication history in the example of FIG. 14.

FIG. 20 is an example of a case of determining the use state in the example of FIG. 14.

FIGS. 21 and 22 are flowcharts for describing the network management process according to the second embodiment.

FIGS. 23A and 23B are examples of a case where a new virtual machine is created in the network illustrated in FIG. 14.

FIGS. 24A to 24C are examples of the measurement instruction in the example of FIG. 14.

FIGS. 25A and 25B and FIGS. 26A and 26B are examples of the communication history in the example of FIG. 14.

FIG. 27 is an example of a case of determining the use state in the example of FIG. 14.

FIG. 28A is an example of the virtual machine communication bandwidth information 133 and the configuration information 136 in the example of FIG. 14.

FIG. 28B is an example of the observation MAC address information 135 in the example of FIG. 14.

### DESCRIPTION OF EMBODIMENTS

### Configuration of Information Processing System

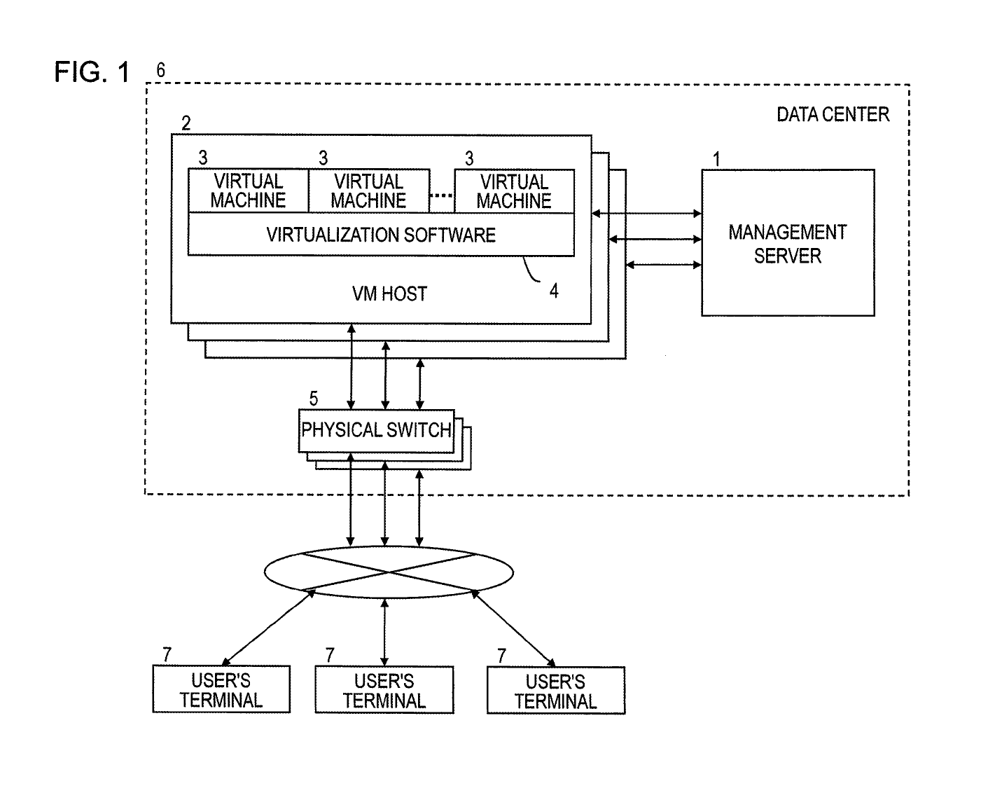

FIG. 1 is a diagram illustrating an entire configuration of an information processing system. A management server 1 (hereinafter also referred to as a management device 1) and a VM host 2 (hereinafter also referred to as an information processing device 2) are provided in a data center 6. Moreover, a user terminal 7 can be connected to the data center 6 via a network such as the Internet or an intranet. Moreover, communication performed between the VM host 2 and the user terminal 7 is performed, for example, via a physical switch 5 (hereinafter also referred to as a physical network device 5) provided in the data center 6.

In the example of FIG. 1, the VM host 2 is made up of a plurality of physical machines, and each physical machine includes a CPU, a memory (DRAM), a large-volume memory such as a hard disk (HDD), and a network. Resources of the VM host 2 are allocated to a plurality of virtual machines 3.

The management server 1 can communicate with the virtual machine 3 and manages the virtual machine 3 created in the VM host 2. The management server 1 may be created by the virtual machine 3, for example.

The virtual machine 3 provides its infrastructure to users via a network, for example (this service is also referred to as a cloud service).

A cloud computing service is a service of providing infrastructure (that is, infrastructure itself such as the virtual machine 3 or a network) for constructing and operating a computer system via a network. Moreover, a user accesses a cloud computing service portal site from the user terminal 7, for example, selects specifications needed for a virtual machine, for example, a CPU clock frequency, a memory volume (GB), a hard disk volume (MB/sec, IOPS), and a network communication bandwidth (Gbps), and makes a contract for cloud computing service under these specifications. Moreover, the user terminal 7 allows users to monitor an operation state of the virtual machine 3 and operate the virtual machine 3, for example.

Virtualization software 4 is infrastructure software that operates the virtual machine 3 by allocating the CPU, the memory, the hard disk, the network of the VM host 2 according to an instruction from the management server 1. The virtualization software 4 is operated by the VM host 2, for example.

The virtual machine 3 is allocated with the resources of the VM host 2 and has a hard disk in which an image file that includes an OS, middleware, applications, databases, and the like is stored. The virtual machine 3 writes the image file from the hard disk to the memory during activation and performs an operation corresponding to a desired service.

A physical switch 5 is an L2 switch, for example, and operates using an MAC address which is an identifier of a datalink layer (second layer) of an OSI reference model. This physical switch 5 analyzes packets transmitted from the VM host 2 or the user terminal 7, for example, to detect a destination and transmits packets to the detected destination only. Moreover, the physical switch 5 allocates packets by configuring a virtual LAN (VLAN) for respective users, for example. The VLAN forms a virtual network independently from a physical connection topology and groups terminals such as the virtual machines 3. VLANs are grouped depending on an MAC address, an IP address, a protocol, and the like by the function of a physical switch, and examples thereof include a port-based VLAN, a tag VLAN, a protocol VLAN, and the like.

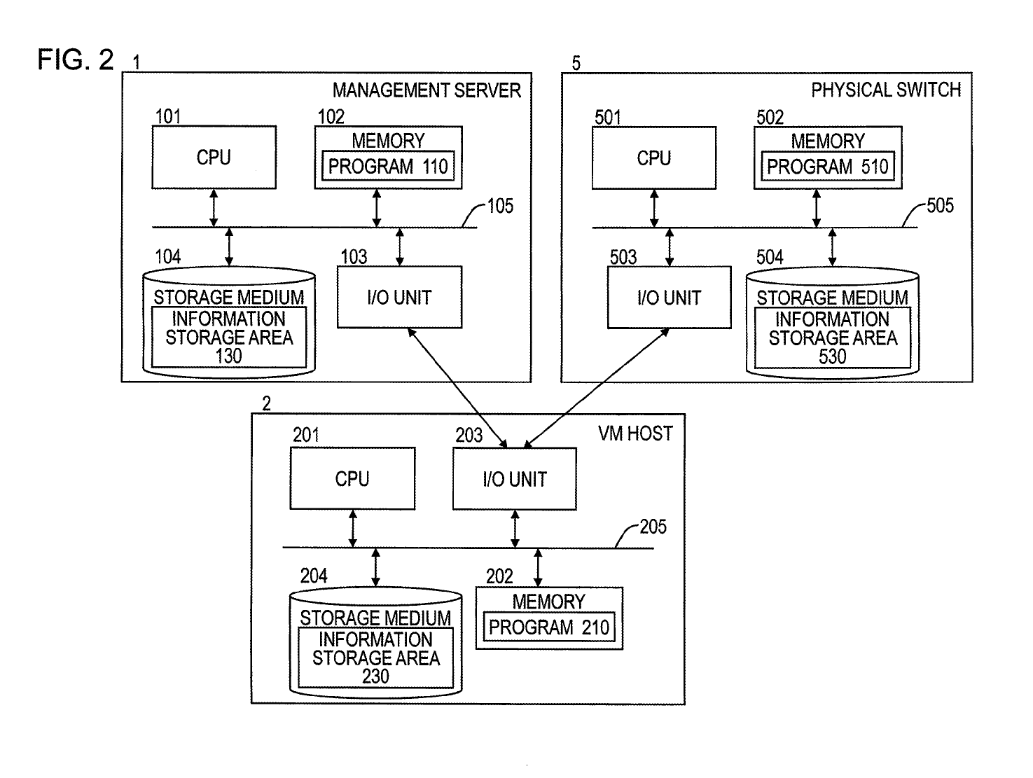

FIG. 2 is a diagram illustrating a hardware configuration of a management server and a VM host. The management server 1 includes a CPU (processor) 101 which is a processor, a memory 102, an external interface (I/O unit) 103, and a storage medium 104. These components are connected to each other by a bus 105. The storage medium 104 stores a program 110 for performing a process of activating the virtual machine 3 in a program storage area (not illustrated) in the storage medium 104, for example. As illustrated in FIG. 2, the CPU 101 loads the program 110 from the storage medium 104 to the memory 102 during execution of the program 110 and, for example, performs a process of activating the virtual machine 3 in cooperation with the program 110. Moreover, the storage medium 104 includes an information storage area 130 for storing information used when performing activation or the like of the virtual machine 3, for example.

The VM host 2 includes a CPU (processor) 201 which is a processor, a memory 202, an external interface (I/O unit) 203, and a storage medium 204. These components are connected to each other via a bus 205. The storage medium 204 stores a program 210 (hereinafter also referred to as a management program 210) for performing a network management process of determining the use state of the physical switch 5 in a program storage area (not illustrated) in the storage medium 204, for example. As illustrated in FIG. 2, the CPU 201 loads the program 210 from the storage medium 204 to the memory 202 during execution of the program 210 and performs a network management process in cooperation with the program 210. Moreover, the storage medium 204 includes an information storage area 230 for storing information used when performing the network management process, for example.

The physical switch 5 includes a CPU (processor) 501 which is a processor, a memory 502, an external interface (I/O unit) 503, and a storage medium 504. These components are connected to each other via a bus 505. The storage medium 504 stores a program 510 for performing a process of storing communication history in a program storage area (not illustrated) in the storage medium 504, for example. As illustrated in FIG. 2, the CPU 501 loads the program 510 from the storage medium 504 to the memory 502 during execution of the program 510 and performs a process of storing communication history in cooperation with the program 510. Moreover, the storage medium 504 includes an information storage area 530 for storing information used when performing a process of storing communication history, for example.

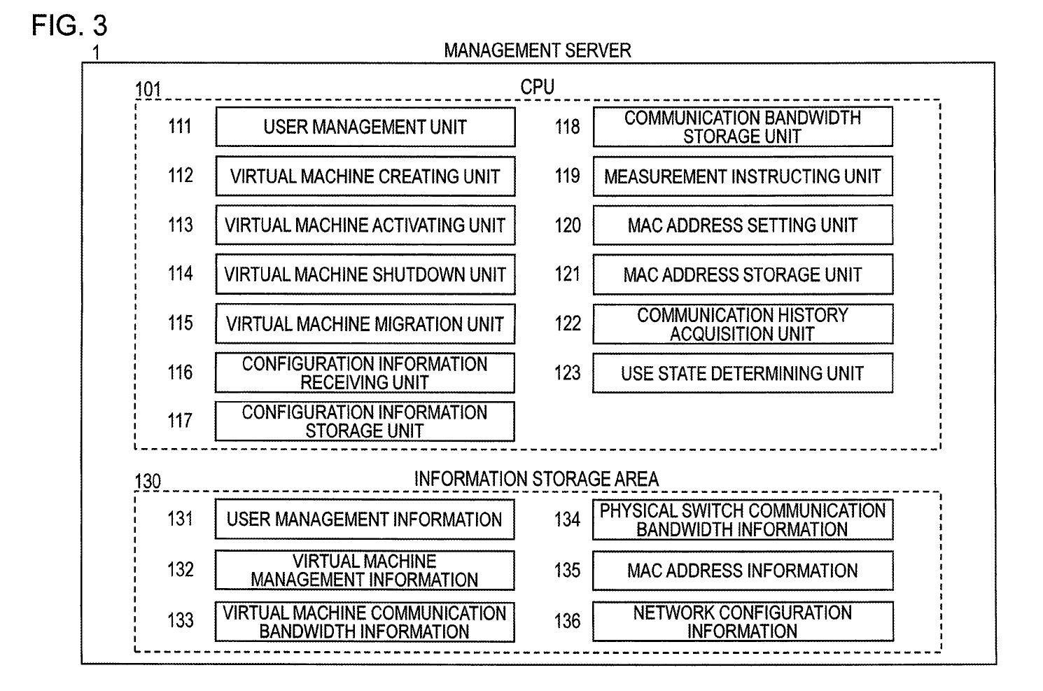

FIG. 3 is a functional block diagram of the management server illustrated in FIG. 2. The CPU 101 cooperates with the program 110 to operate as a user management unit 111, a virtual machine creating unit 112, a virtual machine activating unit 113, a virtual machine shutdown unit 114, and a virtual machine migration unit 115, for example. Moreover, the CPU 101 cooperates with the program 110 to operate as a configuration information receiving unit 116, a configuration information storage unit 117, a communication bandwidth storage unit 118 (hereinafter also referred to as a storage unit 118), a measurement instructing unit 119 (hereinafter also referred to as an instructing unit 119), an MAC address setting unit 120, an MAC address storage unit 121, a communication history acquisition unit 122 (hereinafter also referred to as an acquisition unit 122), and a use state determining unit 123 (hereinafter also referred to as a determining unit 123), for example. Moreover, the information storage area 130 stores user management information 131, virtual machine management information 132, virtual machine communication bandwidth information 133 (hereinafter also referred to as a first communication bandwidth 133), physical switch communication bandwidth information 134 (hereinafter also referred to as a second communication bandwidth 134), MAC address information 135, and network configuration information 136 (hereinafter also referred to as configuration information 136).

The user management unit 111 manages a process of charging users who made a contract for using the virtual machine 3, for example. Moreover, the virtual machine creating unit 112 allocates resources of a physical machine based on a contract for using the virtual machine 3, for example, to create the virtual machine 3. Moreover, the virtual machine activating unit 113 instructs the virtualization software 4 to activate the virtual machine 3, for example. Moreover, the virtual machine shutdown unit 114 instructs the virtualization software 4 to shut down the virtual machine 3 in an active state, for example. Moreover, the virtual machine migration unit 115 instructs the virtualization software 4 to migrate the virtual machine 3, for example.

The configuration information receiving unit 116 receives the configuration information 136 transmitted from the VM host 2, for example. Moreover, the configuration information storage unit 117 stores the configuration information 136 received by the configuration information receiving unit 116, for example, in the information storage area 130. The configuration information 136 will be described later.

The communication bandwidth storage unit 118 stores the first communication bandwidth 133 in which each virtual machine 3 is allowed to perform communication, for example, in the information storage area 130. Moreover, the communication bandwidth storage unit 118 stores the second communication bandwidth 134 in which the port of the physical switch 5 connected to the VM host 2 can communicate, for example, in the information storage area 130. The first communication bandwidth 133 and the second communication bandwidth 134 will be described later.

The measurement instructing unit 119 issues an instruction (hereinafter also referred to as measurement instruction) to the VM host 2 so as to broadcast a measurement packet associated with the virtual machine 3. The measurement packet will be described later.

When the measurement instructing unit 119 issues a measurement instruction by transmitting an MAC address to the VM host 2, the MAC address setting unit 120 sets an MAC address that is unique to a network (broadcast domain) that includes the management server 1 and the VM host 2. Moreover, the MAC address storage unit 121 stores the MAC address transmitted from the measurement instructing unit 119 to the VM host 2 in the information storage area 130 as the MAC address information 135. The MAC address information 135 will be described later.

The communication history acquisition unit 122 accesses the physical switch 5 to acquire communication history of the measurement packet in the port of the physical switch 5. When the physical switch 5 includes a plurality of ports, the communication history acquisition unit 122 may acquire the communication history of each port.

The use state determining unit 123 determines the use state of the physical switch 5 based on the communication history of the physical switch 5 acquired by the communication history acquisition unit 122, the virtual machine communication bandwidth information 133, and the physical switch communication bandwidth information 134. Determination of the use state will be described later.

The user management information 131 is management information on the virtual machine 3, users, the contract thereof, and the like, for example. Moreover, the virtual machine management information 132 is management information that includes operation information of the virtual machine 3 reported from the virtualization software 4, for example.

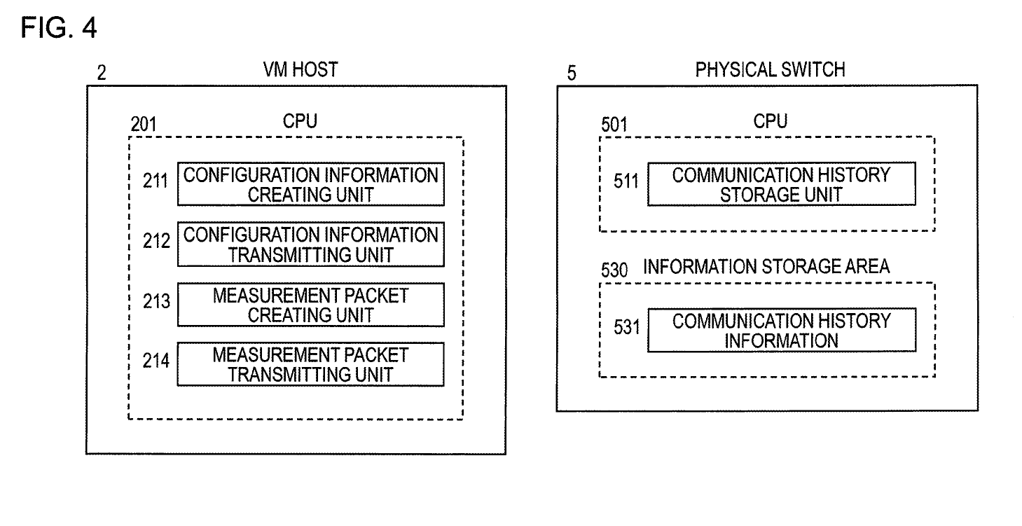

FIG. 4 is a functional block diagram of the VM host and the physical switch illustrated in FIG. 2. The CPU 201 of the VM host 2 cooperates with the program 210 to operate a configuration information creating unit 211, a configuration information transmitting unit 212, a measurement packet creating unit 213, and a measurement packet transmitting unit 214, for example.

The CPU 501 of the physical switch 5 cooperates with the program 510 to operate as a communication history storage unit 511, for example. Moreover, the information storage area 530 stores communication history information 531, for example.

The configuration information creating unit 211 creates the configuration information 136, for example. Moreover, the configuration information transmitting unit 212 transmits the configuration information 136 created by the configuration information creating unit 211 to the management server 1, for example. Moreover, the measurement packet creating unit 213 creates the measurement packet, for example. Moreover, the measurement packet transmitting unit 214 transmits the measurement packet created by the measurement packet creating unit 213 to the management server 1, for example.

The communication history storage unit 511 stores the communication history of the packets relayed by the physical switch 5 in the information storage area 530 as the communication history information 531. The communication history information 531 may include communication history other than the measurement packet.

[Relation Between Virtual Machine and Physical Switch]

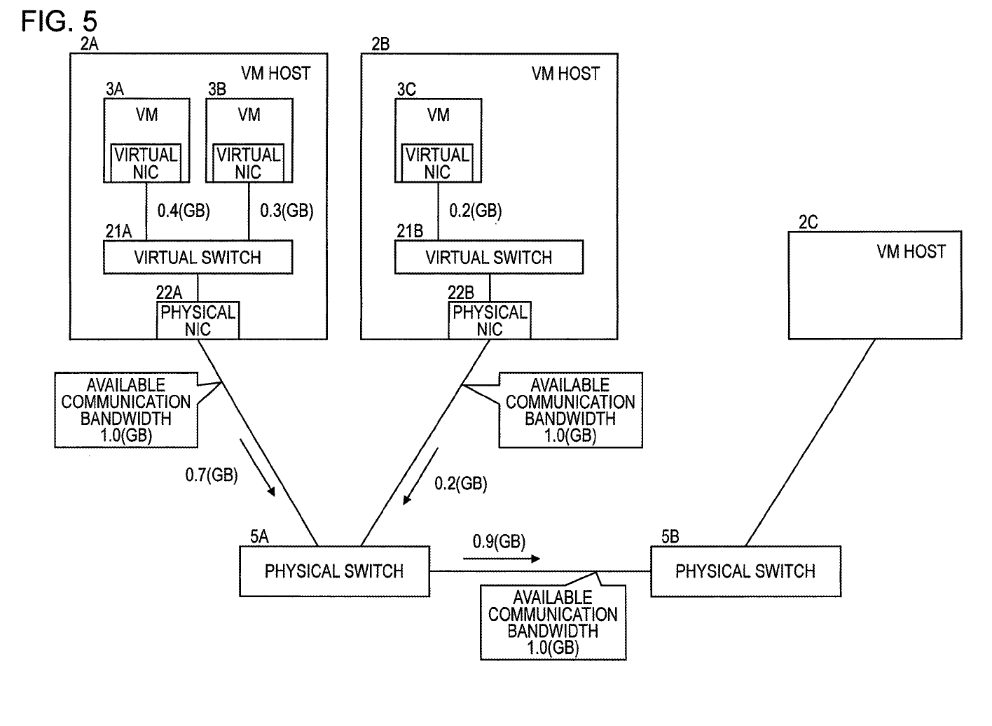

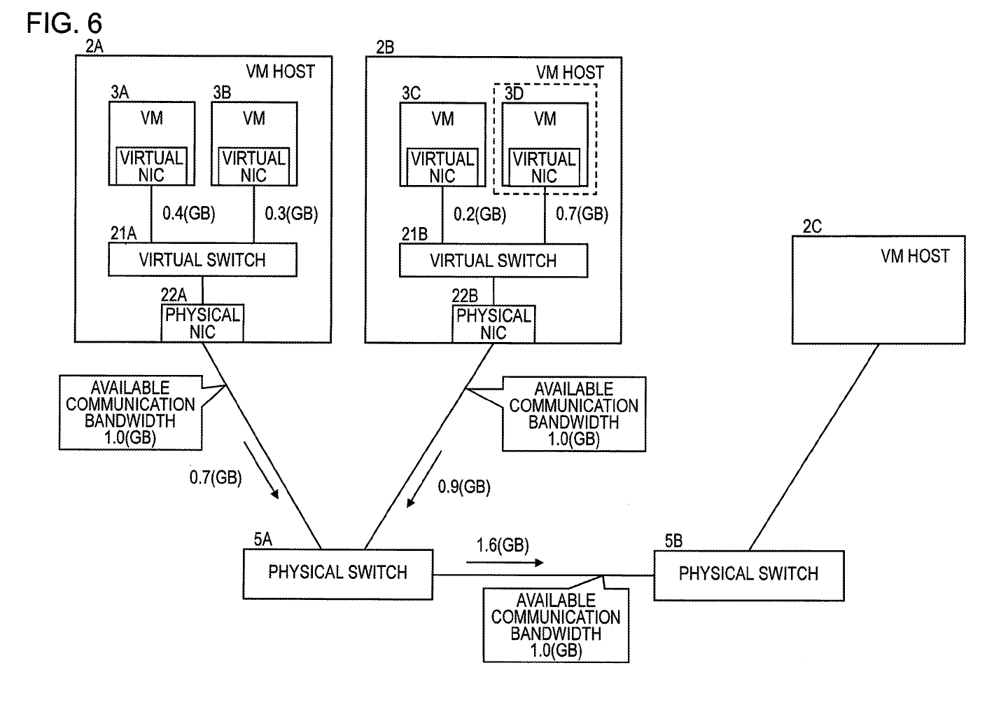

Next, the relation between a virtual machine and a physical switch will be described. FIGS. 5 and 6 are diagrams for describing a general virtual machine and a general physical switch. In the following description, the physical switch will be also referred to as a physical SW, the virtual switch will be also referred to as a virtual SW, and the virtual NIC will be also referred to as a VNIC.

In the example of FIG. 5, a virtual machine 3A and a virtual machine 3B are created in the VM host 2A. A virtual NIC of the virtual machine 3A and a virtual NIC of the virtual machine 3B are virtually connected to a physical NIC 22A via a virtual switch 21A in the VM host 2A. Moreover, a virtual machine 3C is created in the VM host 2B. A virtual NIC of the virtual machine 3C is virtually connected to a physical NIC 22B via a virtual switch 21B in the VM host 2B.

Further, in the example of FIG. 5, a physical NIC 22A of the VM host 2A and a physical NIC 22B of the VM host 2B are connected to a physical switch 5A, and the physical switch 5A is connected to a physical switch 5B. Moreover, the VM host 2C is connected to the physical switch 5B. As illustrated in FIG. 5, a communication line between the physical NIC 22A and the physical switch 5A, a communication line between the physical NIC 22B and the physical switch 5A, and a communication line between the physical switch 5A and the physical switch 5B each have a communication bandwidth of 1.0 (GB).

As illustrated in FIG. 5, the virtual machine 3A requires a communication bandwidth of 0.4 (GB) and the virtual machine 3B requires a communication bandwidth of 0.3 (GB). Due to this, the virtual machine in the VM host 2A requires a communication bandwidth of 0.7 (GB) in the communication line between the physical NIC 22A and the physical switch 5A. Moreover, the virtual machine 3C requires a communication bandwidth of 0.2 (GB). Due to this, the virtual machine in the VM host 2B requires a communication bandwidth of 0.2 (GB) in the communication line between the physical NIC 22B and the physical switch 5A.

Here, when the virtual machines 3A, 3B, and 3C communicate with the VM host 2C only, in the example of FIG. 5, the communication line between the physical switch 5A and the physical switch 5B is used mainly. In this case, the virtual machines 3A, 3B, and 3C use a communication bandwidth of 0.9 (GB) in the communication line between the physical switch 5A and the physical switch 5B. Due to this, in the communication lines of FIG. 5, the communication bandwidth used by the virtual machines 3A, 3B, and 3C does not exceed 1.0 (GB). Thus, in the example illustrated in FIG. 5, bottleneck does not occur in the network.

In contrast, FIG. 6 illustrates a case where a virtual machine 3D is created in the VM host 2B in the state of FIG. 5. As illustrated in FIG. 6, since the virtual machine 3D requires a communication bandwidth of 0.7 (GB), the virtual machine in the VM host 2B requires 0.9 (GB) in the communication line between the physical NIC 22B and the physical switch 5A. Thus, when the virtual machines 3A, 3B, 3C, and 3D communicate with the VM host 2C only, the virtual machines 3A, 3B, 3C, and 3D require a communication bandwidth of 1.6 (GB) which exceeds an available communication bandwidth in the communication line between the physical switch 5A and the physical switch 5B. That is, in the example of FIG. 6, bottleneck occurs in the network depending on a use state of the communication line by the virtual machines 3A, 3B, 3C, and 3D.

As illustrated in the example of FIG. 6, when bottleneck occurs in the network, a service provider needs to eliminate the bottleneck occurred in order to prevent the bottleneck from affecting the user service. However, when the network has a complex configuration, it may be difficult to specify the locations of bottleneck in the network. Moreover, even after the locations of bottleneck are specified, it is needed to take measures such as performing migration in order to eliminate the bottleneck occurred.

Thus, in the present embodiment, the management server 1 broadcasts a measurement packet associated with the virtual machine 3 to the VM host 2 and then acquires communication history of the physical switch 5. Moreover, the management server 1 determines the use state of the physical switch 5 in the network based on the acquired communication history, a communication bandwidth in which the virtual machine 3 is allowed to perform communication, and an available communication bandwidth of the physical switch 5.

### First Embodiment

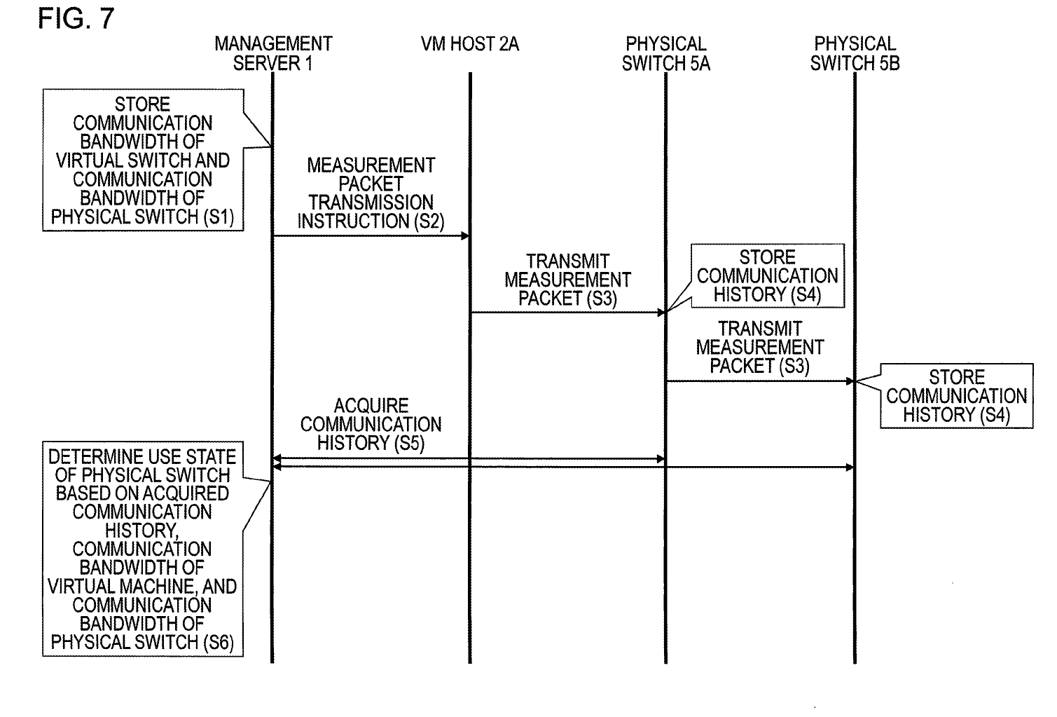

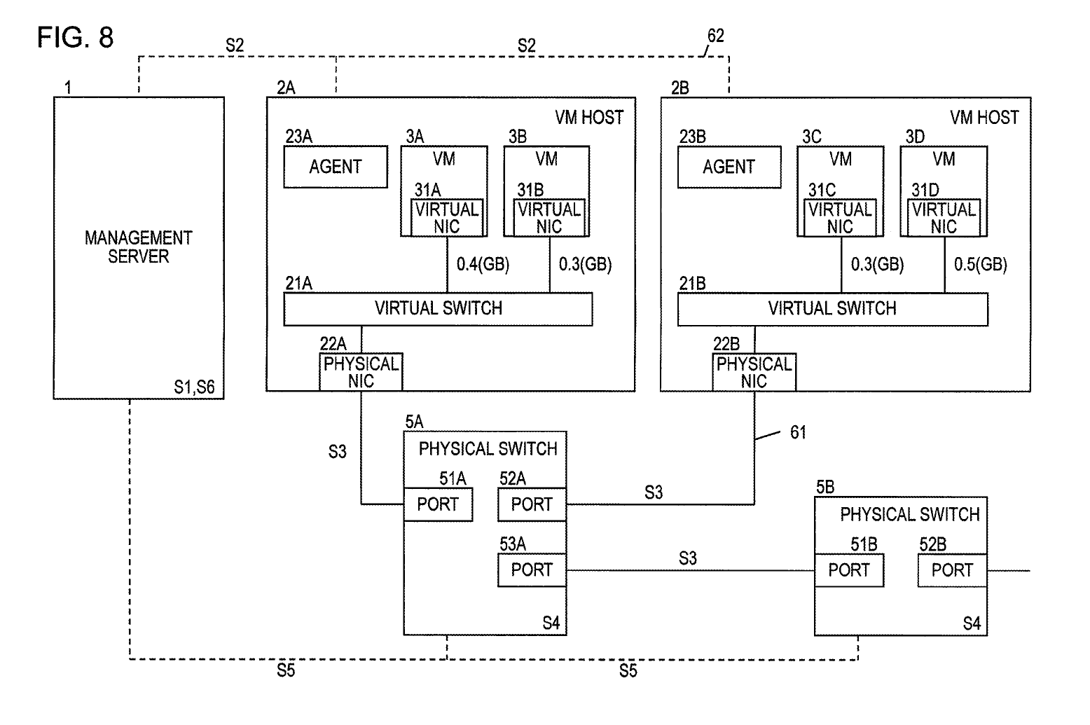

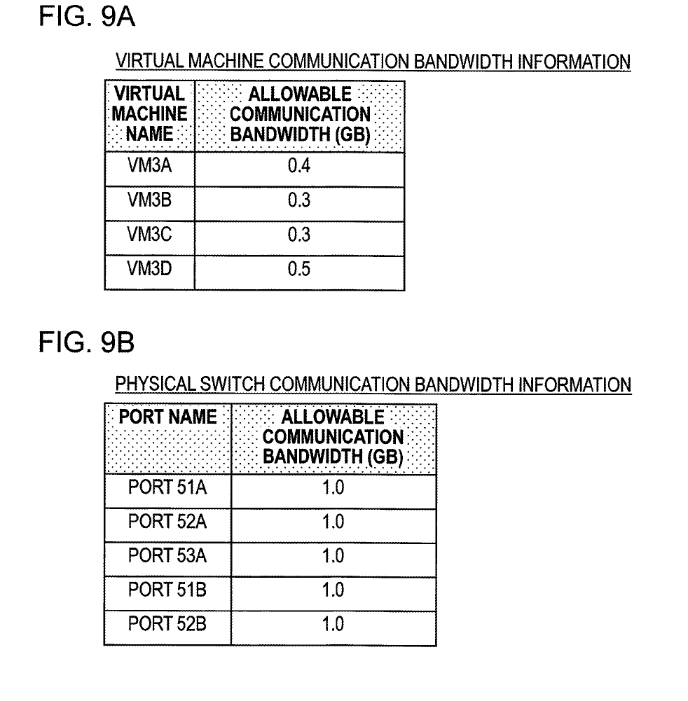

First, the first embodiment will be described. FIG. 7 is a sequence chart for describing an outline of a network management process according to the first embodiment. Moreover, FIG. 8 and FIGS. 9A and 9B are diagrams for describing an outline of a network management process according to the present embodiment. An outline of the network management process of FIG. 7 will be described with reference to FIG. 8 and FIGS. 9A and 9B.

[Network Configuration of FIG. 8]

First, a network configuration of FIG. 8 referred to in the description of FIG. 7 will be described. FIG. 8 is a diagram illustrating the relation between the VM hosts 2A and 2B, the virtual machines 3A, 3B, 3C, and 3D, and the physical switches 5A and 5B.

In the example illustrated in FIG. 8, the virtual machine 3A and the virtual machine 3B are created in the VM host 2A. The virtual NIC 31A of the virtual machine 3A and the virtual NIC 31B of the virtual machine 3B are virtually connected to the physical NIC 22A via the virtual switch 21A in the VM host 2A.

Moreover, the virtual machine 3C and the virtual machine 3D are created in the VM host 2B. The virtual NIC 31C of the virtual machine 3C and the virtual NIC 31D of the virtual machine 3D are virtually connected to the physical NIC 22B via the virtual switch 21B in the VM host 2B.

Further, in the example of FIG. 8, the physical NIC 22A of the VM host 2A and the physical NIC 22B of the VM host 2B are connected to a port 51A and a port 52A of the physical switch 5A, respectively. Moreover, the physical switch 5A has a port 53A connected to a port 51B of the physical switch 5B. In FIG. 8, other components connected to the port 52B of the physical switch 5B are not depicted.

Moreover, in the example of FIG. 8, the VM hosts 2A and 2B include agents 23A and 23B, respectively. The agents 23A and 23B will be described later. In the example of FIG. 8, the VM host 2A, the VM host 2B, the physical switch 5A, and the physical switch 5B are connected by a communication LAN 61 that performs communication for providing a service to users. Moreover, the management server 1, the VM host 2A, the VM host 2B, the physical switch 5A, and the physical switch 5B are also connected by a control LAN 62 that performs communication of the configuration information 136 or the like, needed for performing the network management process. It is assumed that the agents 23A and 23B each can also communicate with the communication LAN 61 and the control LAN 62. Hereinafter, the network management process of FIG. 7 will be described with reference to the example of FIG. 8.

[S1 of FIG. 7]

First, the management server 1 stores the virtual machine communication bandwidth information 133 of the virtual machines 3A, 3B, 3C, and 3D and the physical switch communication bandwidth information 134 of the physical switches 5A and 5B (S1). The virtual machine communication bandwidth information 133 is information on a communication bandwidth in which each virtual machine 3 is allowed to perform communication and is information on a communication bandwidth guaranteed to users. The virtual machine communication bandwidth information 133 is set during contract by users, for example.

Specifically, in the example of FIG. 8, it is assumed that the virtual machines 3A, 3B, 3C, and 3D are allowed to perform communication in communication bandwidths of 0.4 (GB), 0.3 (GB), 0.3 (GB), and 0.5 (GB), respectively. As illustrated in FIG. 9A, the management server 1 stores the virtual machine communication bandwidth information 133 in a state where respective virtual machines are associated with allowable communication bandwidths.

Moreover, the management server 1 stores the physical switch communication bandwidth information 134 of the physical switches 5A and 5B (S1). The physical switch communication bandwidth information 134 is information on a communication bandwidth in which the ports of the physical switches 5A and 5B connected to the VM host 2 can communicate. The physical switch communication bandwidth information 134 is information which is set in advance for respective ports of the physical switches 5A and 5B. Due to this, the management server 1 does not always acquire the physical switch communication bandwidth information 134 from the respective physical switches whenever the network management process is executed. The management server 1 may access the physical switches 5A and 5B to acquire the physical switch communication bandwidth information 134 when the management server 1 constructs a physical network including the physical switches 5A and 5B, for example. Moreover, the management server 1 may access the physical switches 5A and 5B periodically (for example, once everyday) to acquire the physical switch communication bandwidth information 134, for example.

Specifically, in the example of FIG. 8, it is assumed that the ports 51A, 52A, and 53A of the physical switch 5A and the ports 51B and 52B of the physical switch 5B can perform communication in a communication bandwidth of 1.0 (GB). In this case, as illustrated in FIG. 9B, the management server 1 stores the physical switch communication bandwidth information 134 in a state where a port name of each physical switch is associated with an available communication bandwidth of the port.

[S2, S3, and S4 of FIG. 7]

Subsequently, the management server 1 instructs the VM hosts 2A and 2B to broadcast the measurement packets associated with the virtual machines 3A, 3B, 3C, and 3D (S2). Further, the VM hosts 2A and 2B broadcast the measurement packets (S3). The physical switches 5A and 5B having received the measurement packets store communication history indicating the receipt of the measurement packets (S4).

In the example of FIG. 8, the VM hosts 2A and 2B include the agents 23A and 23B, respectively. The agents 23A and 23B receive a measurement instruction from the management server 1 and create measurement packets in response to the measurement instruction. That is, in the example of FIG. 8, the management server 1 may transmit the measurement instruction to the agents 23A and 23B only.

Moreover, after creating the measurement packets, the agents 23A and 23B broadcast the measurement packets. That is, the agents 23A and 23B transmit measurement packets to all devices in a network (hereinafter also referred to as a broadcast domain) divided by a relay or the like that relays packets in Layer 3. Due to this, the agents 23A and 23B transmit measurement packets to other VM hosts and the like in the broadcast domain as well as the physical switches 5A and 5B. Details of the measurement instruction, the measurement packet, and the communication history will be described later.

[S5 and S6 of FIG. 7]

Subsequently, the management server 1 acquires the communication history from the physical switches 5A and 5B (S5) and determines the use state of the physical switches 5A and 5B based on the communication history the virtual machine communication bandwidth information 133 stored in S1 and the physical switch communication bandwidth information 134 stored in S1 (S6).

Specifically, the management server 1 calculates the sum of the respective items of virtual machine communication bandwidth information 133 corresponding to the measurement packets included in the acquired communication history for respective physical switches 5A and 5B and compares the sum with the physical switch communication bandwidth information 134 in the port in which the sum was calculated. When the calculated sum is lower than the physical switch communication bandwidth information 134 in the port, it is determined that bottleneck does not occur in the port and the use state is normal.

That is, the agents 23A and 23B broadcast measurement packets which can be identified for respective virtual machines, for example. Moreover, the communication history of the measurement packet is stored in all physical switches via which the virtual machines 3A, 3B, 3C, and 3D are likely to perform communication. In this way, the management server 1 can calculate the communication bandwidth used by each port based on the communication history acquired from the physical switches and the virtual machine communication bandwidth information 133 stored in advance by the management server 1. Moreover, the management server 1 can determine whether bottleneck is likely to occur in respective physical switches by comparing the communication bandwidth calculated for each port with the physical switch communication bandwidth information 134 stored in advance by the management server 1.

In this manner, according to the first embodiment, the management server 1 stores the virtual machine communication bandwidth information 133 on the communication bandwidths in which the virtual machines 3A, 3B, 3C, and 3D are allowed to perform communication and the physical switch communication bandwidth information 134 on communication bandwidths in which the ports of the physical switches 5A and 5B connected to the VM hosts 2A and 2B are allowed to perform communication. Moreover, the management server 1 instructs the VM hosts 2A and 2B to broadcast measurement packets associated with the respective virtual machines. Further, the management server 1 acquires the communication history of the measurement packet at the ports of the physical switches 5A and 5B and determines the use state of the physical switches 5A and 5B based on the acquired communication history, the virtual machine communication bandwidth information 133, and the physical switch communication bandwidth information 134. In this way, the management server 1 can determine whether bottleneck occurs in the network.

### Details of First Embodiment

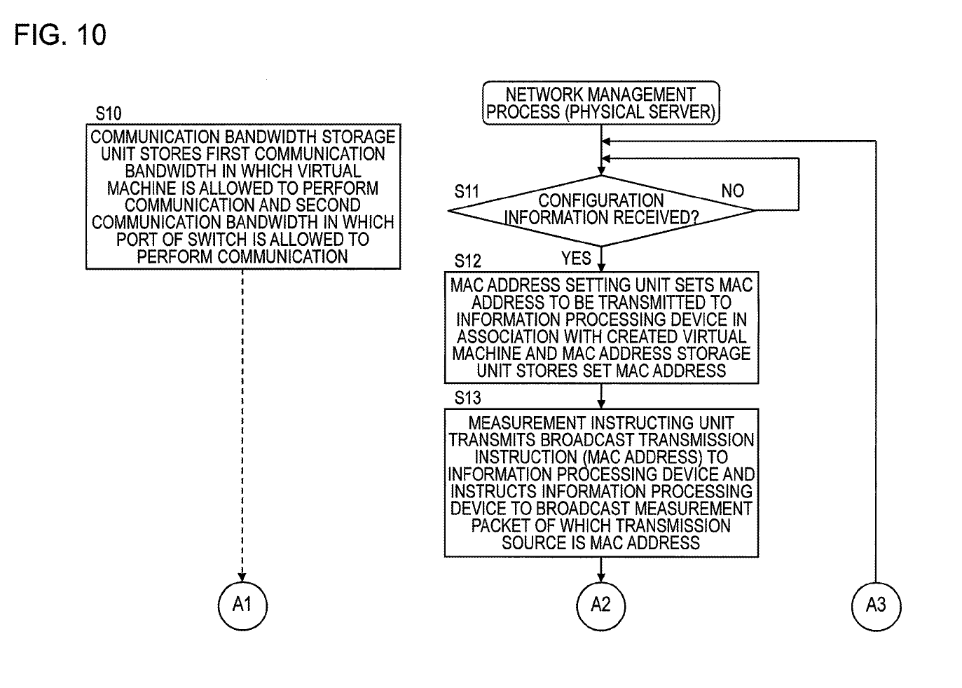

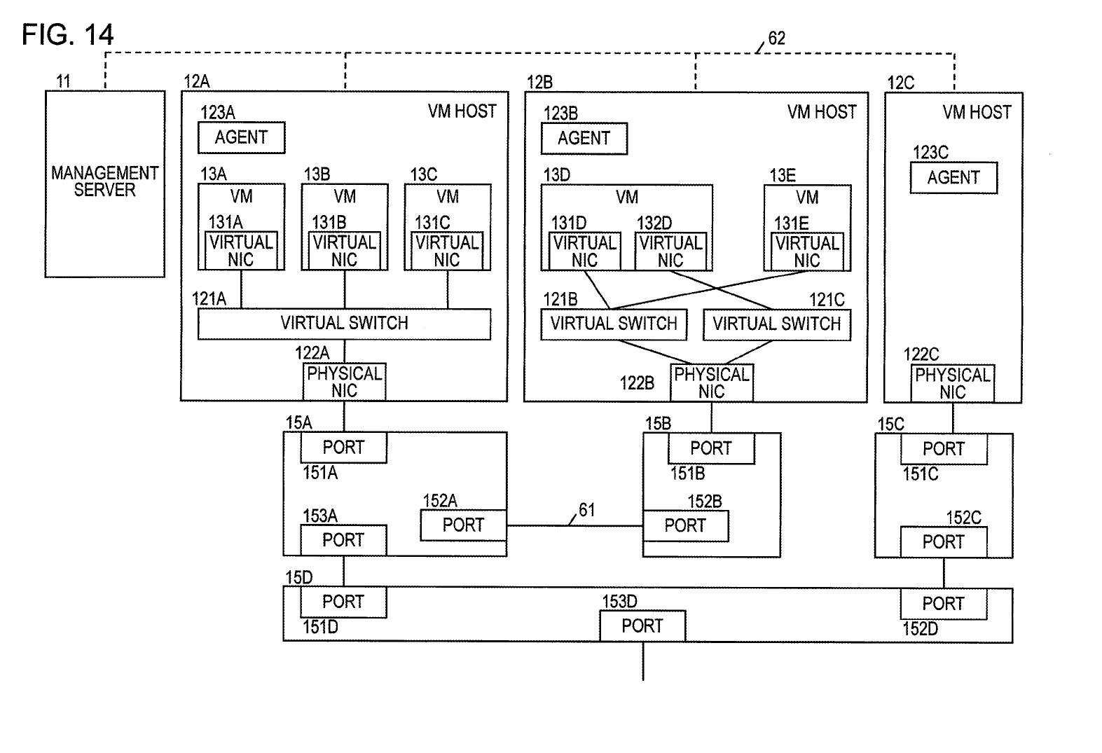

Next, the details of the first embodiment will be described. FIGS. 10 to 13 are flowcharts for describing the details of the network management process according to the first embodiment. Moreover, FIGS. 14 to 20 are diagrams for describing the details of the network management process according to the first embodiment. The details of the network management process in FIGS. 10 to 13 will be described with reference to FIGS. 14 to 20.

[Network Configuration of FIG. 14]

First, the network configuration of FIG. 14 referred to in the description of FIGS. 10 to 13 will be described. FIG. 14 is a diagram illustrating the relation between VM hosts 12A, 12B, and 12C, virtual machines 13A to 13E, and physical switches 15A to 15D.

In the example illustrated in FIG. 14, virtual machines 13A, 13B, and 13C are created in the VM host 12A. A virtual NIC 131A of the virtual machine 13A, a virtual NIC 131B of the virtual machine 13B, and a virtual NIC 131C of the virtual machine 13C are virtually connected to a physical NIC 122A via a virtual switch 121A in the VM host 12A. Moreover, virtual machines 13D and 13E are created in the VM host 12B. A virtual NIC 131D of the virtual machine 13D and a virtual NIC 131E of the virtual machine 13E are virtually connected to a physical NIC 122B via a virtual switch 121B in the VM host 12B. Moreover, a virtual NIC 132D of the virtual machine 13D is virtually connected to a physical NIC 122B via a virtual switch 121C in the VM host 12B. Further, the VM host 12C includes a physical NIC 122C but a virtual machine is not created.

Moreover, in the example of FIG. 14, the physical NIC 122A of the VM host 12A is connected to a port 151A of the physical switch 15A. Moreover, the physical NIC 122B of the VM host 12B is connected to a port 151B of the physical switch 15B. Moreover, the physical NIC 122C of the VM host 12C is connected to a port 151C of the physical switch 15C. Moreover, a port 152A of the physical switch 15A is connected to a port 152B of the physical switch 15B, a port 153A of the physical switch 15A is connected to a port 151D of the physical switch 15D, and a port 152C of the physical switch 15C is connected to a port 152D of the physical switch 15D. Other components connected to the port 153D of the physical switch 15D are not depicted.

Moreover, in the example of FIG. 14, the VM hosts 12A, 12B, and 12C include agents 123A, 123B, and 123C, respectively. The VM hosts 12A, 12B, and 12C and the physical switches 15A, 15B, 15C, and 15D are connected by a communication LAN 61. Further, the management server 1, the VM hosts 12A, 12B, and 12C, and the physical switches 15A, 15B, 15C, and 15D are connected by a control LAN 62. It is assumed that the agents 123A, 123B, and 123C each can communicate with the communication LAN 61 and the control LAN 62. Hereinafter, the network management process of FIGS. 10 to 13 will be described with reference to the example of FIG. 14.

[Process of Management Server]

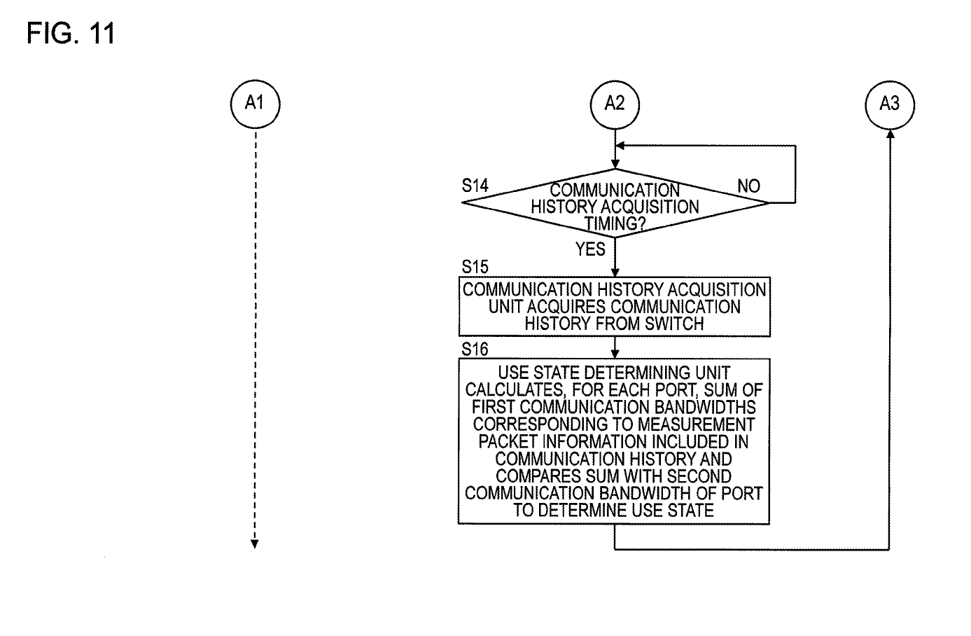

First, the network management process executed by a management server 11 will be described. FIGS. 10 and 11 are diagrams for describing the network management process executed by the management server. In the flowchart on the left side of FIG. 10, a communication bandwidth storage unit 118 of the management server 11 stores the virtual machine communication bandwidth information 133 and the physical switch communication bandwidth information 134 in the background of the network management process (S10).

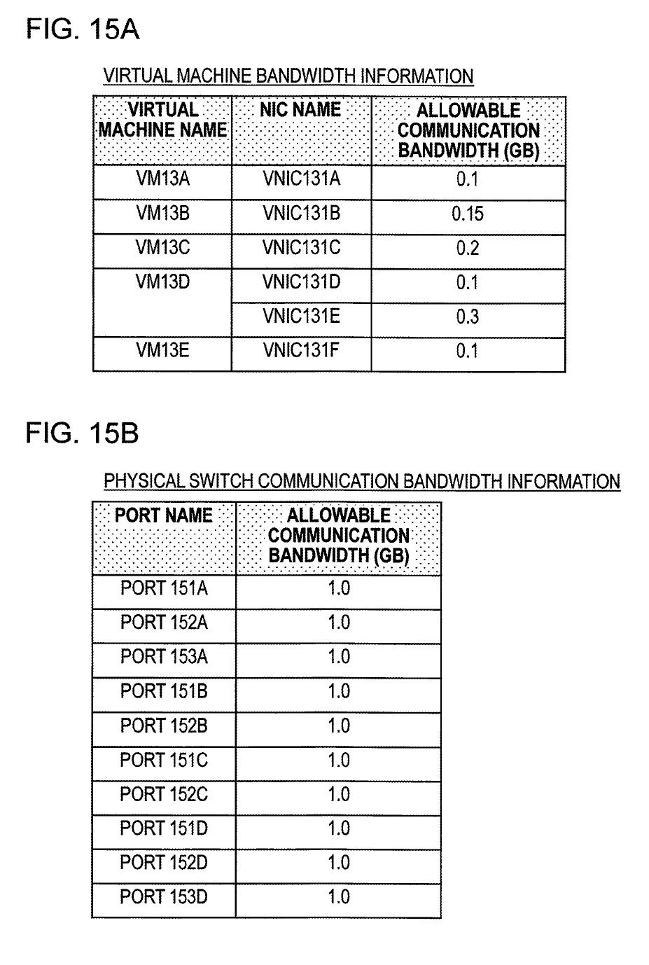

FIG. 15A is an example of the virtual machine communication bandwidth information 133 in the example of FIG. 14. In FIG. 14, the virtual machine 13D includes the virtual NIC 131D and the virtual NIC 132D. Due to this, the virtual machine communication bandwidth information 133 in FIG. 15A stores an allowable communication bandwidth of each virtual NIC unlike those described in FIGS. 9A and 9B. That is, for example, when a virtual machine has a plurality of functions, the virtual machine may have different connection destinations for respective functions. In this case, it is needed to allocate different virtual NICs to respective functions so that the respective virtual NICs belong to different VLANs. Thus, in the example of FIG. 15A, the communication bandwidth storage unit 118 stores allowable communication bandwidths for respective virtual NICs rather than for respective virtual machines. In this manner, the management server 11 can determine the use state of the physical switch accurately even when the connection destinations are different for respective functions of the virtual machine.

FIG. 15B is an example of the physical switch communication bandwidth information 134 in the example of FIG. 14. In the example of FIG. 15B, the ports of the respective physical switches have an available communication bandwidth of 1.0 (GB).

Returning to FIG. 10, in the flowchart on the right side of FIG. 10, the configuration information receiving unit 116 of the management server 11 performs standby until the configuration information 136 is transmitted from the respective VM hosts, for example (S11: NO). The configuration information 136 is information including the information on VM hosts created by respective virtual machines and the information on a VLAN to which the respective virtual machines belong, for example. This configuration information 136 may be transmitted from respective VM hosts to the management server 11 periodically (for example, every 10 minutes). Alternatively, the configuration information 136 may be transmitted from respective VM hosts to the management server 11 in response to an instruction from the management server 11. Due to this, even when the configuration information 136 is changed according to an operation of users or the like, the management server 11 can determine the use state of the physical switch with the change being reflected. When the configuration information receiving unit 116 receives the configuration information 136, the management server 11 may transmit a measurement instruction to the respective VM hosts in response to the reception. The agents 123A, 123B, and 123C in the respective virtual machines may create the configuration information 136 and transmit the same to the management server 11.

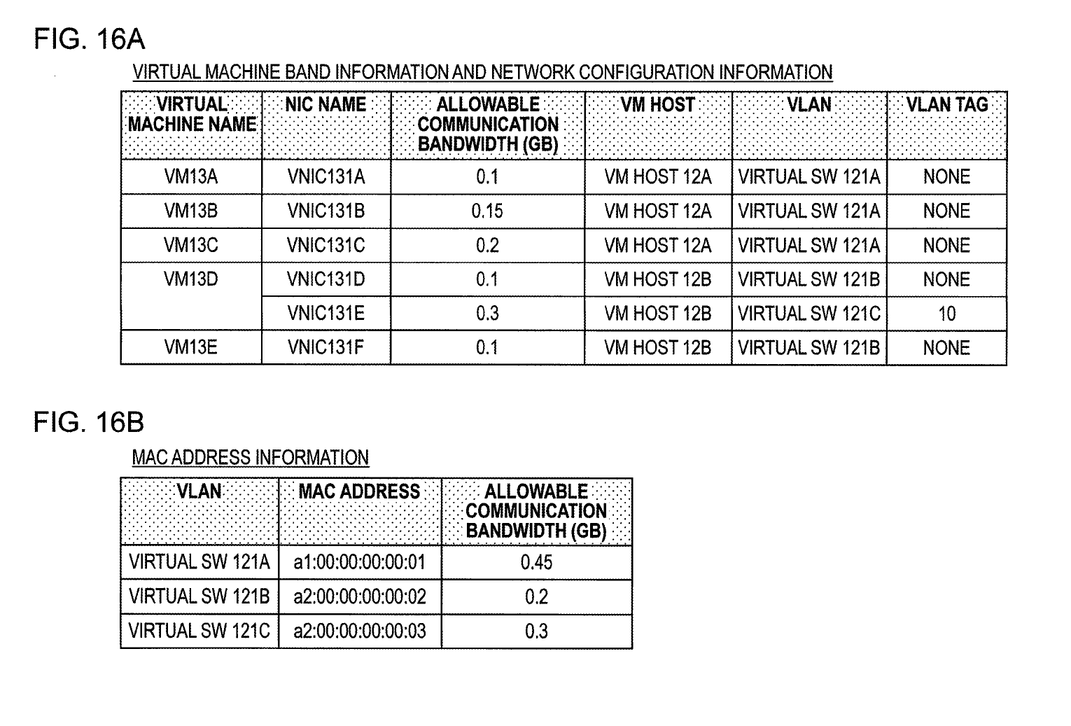

FIG. 16A is an example of the virtual machine communication bandwidth information 133 and the configuration information 136 in the example of FIG. 14. The configuration information 136 in the example of FIG. 16A includes information on a VM host created by each virtual machine, information on a VLAN to which each virtual NIC belongs, and tag information of a VLAN. In FIG. 16A, for example, the configuration information 136 of the virtual NIC 131B of the virtual machine 13B indicates that the virtual machine 13B is created in the VM host 12A and a VLAN to which the virtual NIC 131B belongs is the VLAN to which the virtual SW 121B belongs. Further, the configuration information 136 indicates that no tag is appended to a packet transmitted from the virtual NIC 131B.

Moreover, in FIG. 16A, for example, the configuration information 136 of the virtual NIC 131E of the virtual machine 13E indicates that the virtual machine 13D is created in the VM host 12B and a VLAN to which the virtual NIC 131D belongs is the VLAN to which the virtual SW 121C belongs. Further, the configuration information 136 indicates that a tag “10” is appended to a packet transmitted from the virtual NIC 131E.

In the example of FIG. 14, since a virtual machine is not created in the VM host 12C, the information on the VM host 12C is not included in FIG. 16A.

Returning to FIG. 10, for example, when the configuration information receiving unit 116 receives the configuration information 136 (S11: YES), the MAC address setting unit 120 of the management server 11 sets the MAC address information 135 in which each of the created virtual machines is associated with an MAC address that the management server 11 transmits to each VM host. Moreover, the MAC address storage unit 121 of the management server 11 stores the MAC address information 135 set by the MAC address setting unit 120 (S12). Further, the measurement instructing unit 119 of the management server 11 transmits a measurement instruction to respective VM hosts (S13). Specifically, the measurement instructing unit 119 transmits the MAC address set by the MAC address setting unit 120, for example, to respective VM hosts as the measurement instruction to be transmitted to the respective VM hosts.

When the management server 11 can acquire the configuration information by itself (without receiving the same from the respective VM hosts), the MAC address setting unit 120 may set the MAC address information 135 without performing standby until the configuration information is received by the configuration information receiving unit 116. In this case, the MAC address setting unit 120 may set the MAC address information 135 by itself at predetermined points in time (for example, every 10 minutes) and start the subsequent network management process.

FIG. 16B is an example of the MAC address information 135 in the example of FIG. 14. The MAC address information 135 in the example of FIGS. 16A and 16B includes the VLAN information, the MAC address set by the MAC address setting unit 120, and the sum of allowable communication bandwidths of virtual machines included in the VLAN. In the example of FIG. 16B, the MAC address setting unit 120 sets the MAC address in association with the VLAN (for respective VLANs).

Specifically, in the example of FIG. 16B, the MAC address setting unit 120 sets 0.45 (GB) which is the sum of allowable communication bandwidths of the virtual NICs 131A, 131B, and 131C to the allowable communication bandwidth in association with the VLAN to which the virtual switch 121A belongs, for example. Further, the MAC address setting unit 120 sets the MAC address “a1:00:00:00:00:01” in association with the VLAN to which the virtual switch 121A belongs.

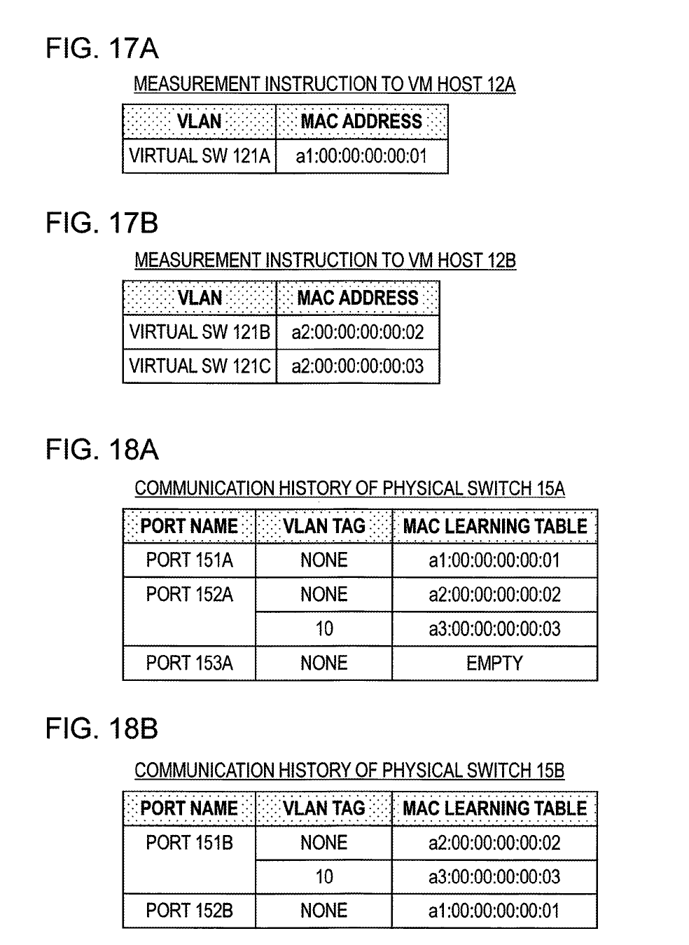

Next, the measurement instruction and the measurement packet will be described. FIGS. 17A and 17B are examples of the measurement instruction in the example of FIG. 14. In the examples of FIGS. 17A and 17B, the measurement instructing unit 119 transmits the VLAN information and the MAC address among the items of MAC address information 135 to respective VM hosts as the measurement instruction. In the examples of FIGS. 17A and 17B, the measurement instructing unit 119 transmits information on a VLAN to which the virtual SW 121A belongs to the VM host 12A as illustrated in FIG. 17A and transmits information on a VLAN to which the virtual SW 121B belongs and a VLAN to which the virtual SW 121C belongs to the VM host 12B as illustrated in FIG. 17B. That is, the measurement instructing unit 119 transmits information on respective VLANs to the VM hosts to which the VLANs are present. Moreover, the respective VM hosts broadcast measurement packets and respective physical switches store communication history of the measurement packets.

The measurement packet may be a packet of which the source MAC address is the MAC address set by the MAC address setting unit 120 and the destination MAC address is the broadcast address. Further, the measurement packet may be a packet which does not include a data body but includes a header only.

Returning to FIG. 11, the communication history acquisition unit 122 performs standby until the communication history is acquired from respective physical switches (S14: NO). Then, the communication history acquisition unit 122 acquires communication history from respective physical switches (S15) at the point in time when communication history is acquired from respective physical switches (S14: YES). The point in time of acquiring the communication history may be several seconds later than the point in time when the measurement instructing unit 119 transmits the measurement instruction to respective VM hosts, for example. That is, the point in time when the communication history acquisition unit 122 acquires the communication history may be at least later than the point in time when the measurement packets transmitted by respective VM hosts reach respective physical switches.

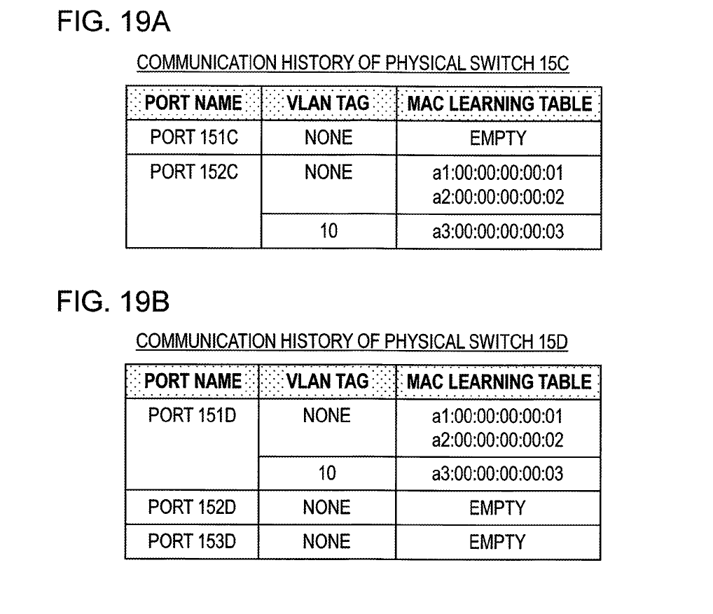

FIGS. 18A and 18B and FIGS. 19A and 19B are examples of the communication history in the example of FIG. 14. The communication history in FIGS. 18A and 18B and FIGS. 19A and 19B include a port name of a port of a physical switch, tag information of a VLAN, and an MAC learning table. The MAC learning table stores the MAC addresses of packets relayed by a port. Hereinafter, a specific example of broadcasting of the measurement packet in the example of FIG. 14 will be described.

As illustrated in FIG. 14, the VM host 12A broadcasts a measurement packet of which the source MAC address is “a 1:00:00:00:00:01” as illustrated in FIGS. 17A and 17B (hereinafter this measurement packet will be referred to as a measurement packet A).

First, the measurement packet A is transmitted to the port 151A of the physical switch 15A via the physical NIC 122A of the VM host 12A. Due to this, as illustrated in FIG. 18A, an MAC address “a1:00:00:00:00:01” is stored in the MAC learning table to which no tag is appended, of the port 151A of the physical switch 15A. Subsequently, the measurement packet A is transmitted to the port 152B of the physical switch 15B via the port 152A of the physical switch 15A. Moreover, the measurement packet A is transmitted to the port 151D the physical switch 15D via the port 153A of the physical switch 15A. Further, the measurement packet A is transmitted to the port 152C of the physical switch 15C via the port 152D of the physical switch 15D. Due to this, as illustrated in FIG. 18B, an MAC address “a1:00:00:00:00:01” is stored in the MAC learning table to which no tag is appended, of the port 152B of the physical switch 15B. Moreover, as illustrated in FIGS. 19A and 19B, an MAC address “a1:00:00:00:00:01” is stored in the MAC learning table to which no tag is appended, of the port 152C of the physical switch 15C and the MAC learning table to which no tag is appended, of the port 151D of the physical switch 15D.

In FIG. 14, two VLANs which are the VLAN to which the virtual SW 121B belongs and the VLAN to which the virtual SW 121C belongs are present in the VM host 12B. Thus, as illustrated in FIGS. 17A and 17B, the VM host 12B transmits a measurement packet of which the source MAC address is “a2:00:00:00:00:02” and a measurement packet of which the source MAC address is “a3:00:00:00:00:03” (hereinafter these measurement packets will be referred to as measurement packets B and C, respectively). In this case, although a tag is not appended to the measurement packet B, a tag “10” is appended to the measurement packet C.

First, the measurement packet B is transmitted to the port 151B of the physical switch 15B via the physical NIC 122B of the VM host 12B. Due to this, as illustrated in FIG. 18B, an MAC address “a2:00:00:00:00:02” is stored in the MAC learning table to which no tag is appended, of the port 151B of the physical switch 15B. Subsequently, the measurement packet B is transmitted to the port 152A of the physical switch 15A via the port 152B of the physical switch 15B. Further, the measurement packet B is transmitted to the port 151D of the physical switch 15D via the port 153A of the physical switch 15A. Further, the measurement packet B is transmitted to the port 152C of the physical switch 15C via the port 152D of the physical switch 15D. Due to this, as illustrated in FIG. 18A, an MAC address “a2:00:00:00:00:02” is stored in the MAC learning table to which no tag is appended, of the port 152A of the physical switch 15A. Moreover, as illustrated in FIGS. 19A and 19B, an MAC address “a2:00:00:00:00:02” is stored in the MAC learning table to which no tag is appended, of the port 152C of the physical switch 15C and the MAC learning table to which no tag is appended, of the port 151D of the physical switch 15D.

On the other hand, the measurement packet C is first transmitted to the port 151B of the physical switch 15B via the physical NIC 122B of the VM host 12B. Due to this, as illustrated in FIG. 18B, an MAC address “a3:00:00:00:00:03” is stored in the MAC learning table to which a tag “10” is appended, of the port 151B of the physical switch 15B. Subsequently, the measurement packet C is transmitted to the port 152A of the physical switch 15A via the port 152B of the physical switch 15B. Further, the measurement packet C is transmitted to the port 151D of the physical switch 15D via the port 153A of the physical switch 15A. Further, the measurement packet C is transmitted to the port 152C of the physical switch 15C via the port 152D of the physical switch 15D. Due to this, as illustrated in FIG. 18A, an MAC address “a3:00:00:00:00:03” is stored in the MAC learning table to which a tag “10” is appended, of the port 152A of the physical switch 15A. Moreover, as illustrated in FIGS. 19A and 19B, an MAC address “a3:00:00:00:00:03” is stored in the MAC learning table to which a tag “10” is appended, of the port 152C of the physical switch 15C and the MAC learning table to which a tag “10” is appended, of the port 151D of the physical switch 15D.

Each physical switch may create the communication history in such a manner to include the physical switch communication bandwidth information 134 of each port. By doing so, each physical switch can transmit the physical switch communication bandwidth information 134 to the management server 11 simultaneously with transmission of the communication history.

Returning to FIG. 11, the use state determining unit 123 of the management server 11 calculates the sum of the virtual machine communication bandwidth information 133 corresponding to the MAC address included in the communication history and compares the sum with the physical switch communication bandwidth information 134 of the port to thereby determine the use state of each physical switch (S16).

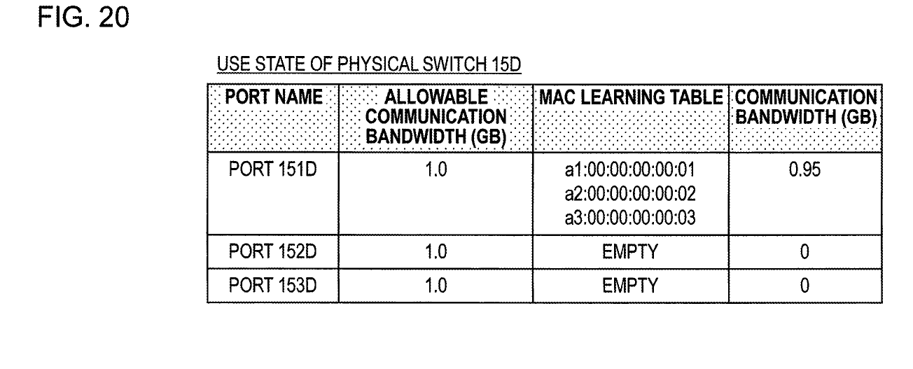

FIG. 20 is an example of a case of determining the use state in the example of FIG. 14. In the example of FIG. 20, a case of determining the use state of the physical switch 15D is described.

The MAC addresses “a1:00:00:00:00:01”, “a2:00:00:00:00:02”, and “a3:00:00:00:00:03” are stored in the communication history of the port 151D of the physical switch 15D, received by the management server 1 as illustrated in FIG. 19B. Due to this, the use state determining unit 123 calculates the sum of allowable communication bandwidths corresponding to respective MAC addresses by referring to the MAC address information 135 of FIG. 16B. Specifically, according to the MAC address information 135 of FIG. 16B, the communication bandwidths corresponding to the MAC addresses “a1:00:00:00:00:01”, “a2:00:00:00:00:02”, and “a3:00:00:00:00:03” are 0.45 (GB), 0.2 (GB), and 0.3 (GB), respectively. Thus, the sum of the allowable communication bandwidths is 0.95 (GB), as illustrated in FIG. 20.

Subsequently, the use state determining unit 123 acquires the available communication bandwidth of the port 151D by referring to the physical switch communication bandwidth information 134 of FIG. 15B and compares the sum of the calculated allowable communication bandwidths with the available communication bandwidth of the port 151D. For example, when the sum of the calculated allowable communication bandwidths is smaller than the available communication bandwidth of the port 151D, the use state determining unit 123 determines that the use state of the port 151D is normal (bottleneck has not occurred in the port 151D).

Specifically, in the example of FIG. 20, the sum (0.95 (GB)) of the calculated allowable communication bandwidths is smaller than the available communication bandwidth (1.0 (GB)) of the port 151D. Thus, the use state determining unit 123 determines that the use state of the port 151D is normal. In the example of FIG. 20, since the communication history is not stored in the ports 152D and 153D of the physical switch 15D, it can be determined that these ports are not used at present. Thus, the use state determining unit 123 determines that the use state of the ports 152D and 153D is normal.

That is, the MAC address setting unit 120 sets the VLAN information, the MAC address, and the sum of allowable communication bandwidths of the virtual machines included in the VLAN in association. Moreover, the measurement instructing unit 119 transmits information on the MAC address as a measurement instruction. Subsequently, each VM host broadcasts the measurement packet, the source MAC address of which is the MAC address received, and each physical switch stores the source MAC address of the measurement packet received as communication history. Moreover, the communication history acquisition unit 122 acquires the communication history from respective physical switches to thereby acquire information on the source MAC address of the measurement packets relayed by the respective physical switches. In this way, the use state determining unit 123 can acquire information on a VLAN associated with the MAC address and information on the allowable communication bandwidths of the virtual machines included in the VLAN based on information on the MAC address acquired by the communication history acquisition unit 122. Thus, the use state determining unit 123 can determines the use state of respective physical switches based on the communication history acquired by the communication history acquisition unit 122.

[Process of VM Host]

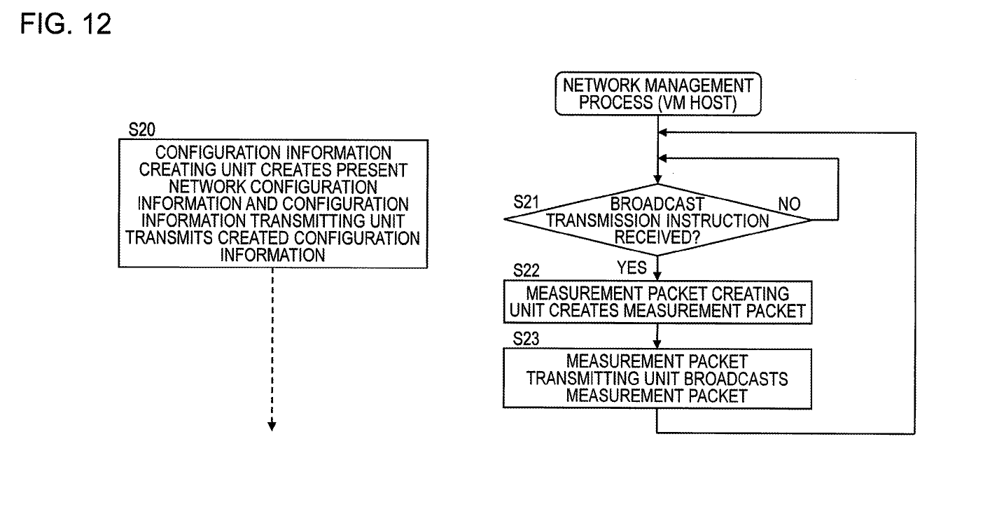

Next, the network management process executed by the VM hosts 12A, 12B, and 12C will be described. FIG. 12 is a diagram for describing the network management process executed by the VM hosts 12A, 12B, and 12C. In the flowchart on the left side of FIG. 12, the configuration information creating unit 211 of the VM hosts 12A, 12B, and 12C creates the configuration information 136 on the present network in the background of the network management process. The configuration information transmitting unit 212 transmits the configuration information 136 created by the configuration information creating unit 211 to the management server 11 (S20). In the example of FIG. 14, although the virtual machine is not created in the VM host 12C, the configuration information creating unit 211 may create the configuration information 136 of the VM host 12C similarly to the VM hosts 12A and 12B. Moreover, the configuration information creating unit 211 may create the configuration information 136 of the VM host 12C for the first time when a virtual machine is created in the VM host 12C.

Next, the flowchart on the left side of FIG. 12 will be described. The VM hosts 12A, 12B, and 12C perform standby until a measurement instruction is received from the management server 11 (S21: NO). When the measurement instruction is received from the management server 11 (S21: YES), the measurement packet creating unit 213 of the VM hosts 12A, 12B, and 12C creates the measurement packet described in FIG. 10 (S22). Subsequently, the measurement packet transmitting unit 214 broadcasts the measurement packet created by the measurement packet creating unit 213 (S23). After the measurement packet is broadcasted, the VM hosts 12A, 12B, and 12C perform standby until the next measurement instruction is received (S21). The configuration information creating unit 211, the configuration information transmitting unit 212, the measurement packet creating unit 213, and the measurement packet transmitting unit 214 may be functions possessed by the agents 123A, 123B, and 123C described in FIG. 10.

[Process of Physical Switch]

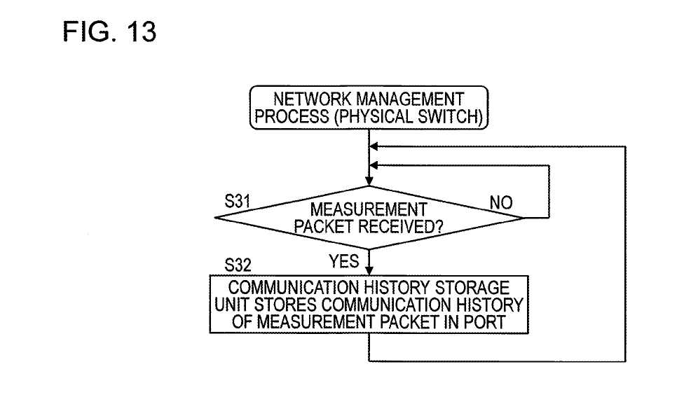

Next, the network management process executed by the physical switches 15A, 15B, 15C, and 15D will be described. FIG. 13 is a diagram for describing the network management process executed by the physical switches 15A, 15B, 15C, and 15D. The physical switches 15A, 15B, 15C, and 15D perform standby until the physical switches 15A, 15B, 15C, and 15D receive (relay) the measurement packets from the VM hosts 12A, 12B, and 12C (S31: NO). Then, when the physical switches 15A, 15B, 15C, and 15D receive (relay) the measurement packets from the VM hosts 12A, 12B, and 12C (S31: YES), the communication history storage unit 511 of the physical switches 15A, 15B, 15C, and 15D stores the communication history described in FIG. 10 in the information storage area 530 (S32). After the communication history is stored, the physical switches 15A, 15B, 15C, and 15D perform standby until a measurement packet is received from the VM hosts 12A, 12B, and 12C (S31). The communication history storage unit 511 may store communication history of a packet other than the measurement packet.

### Second Embodiment

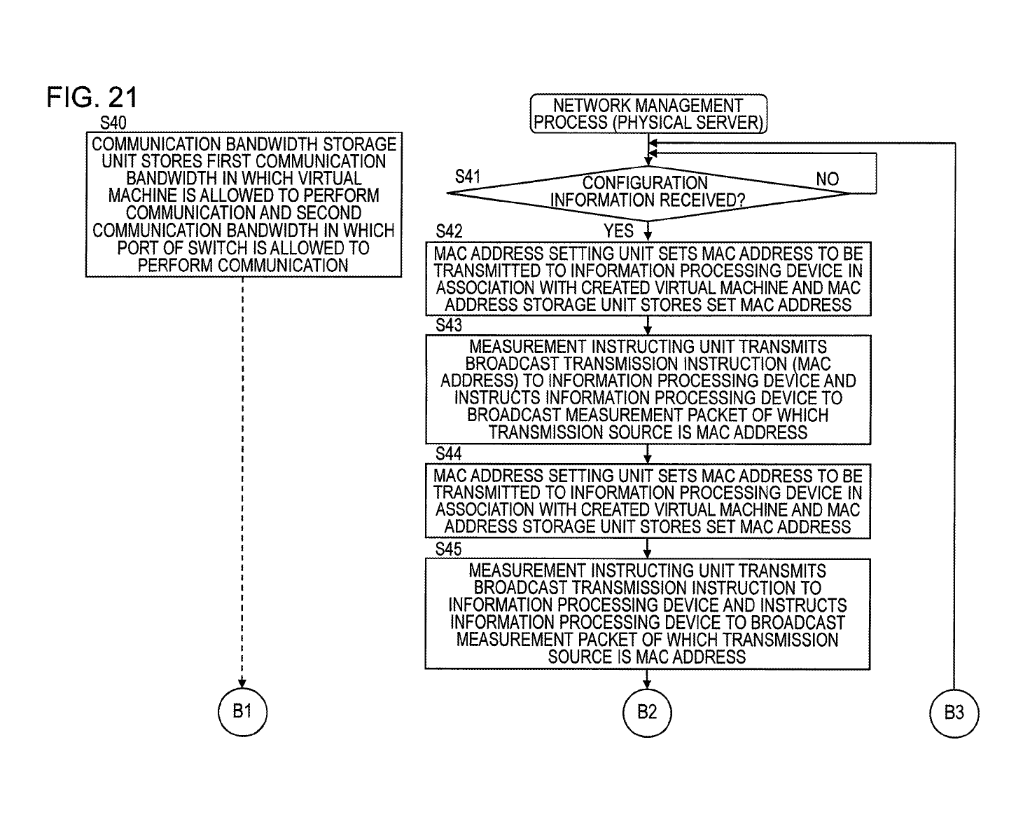

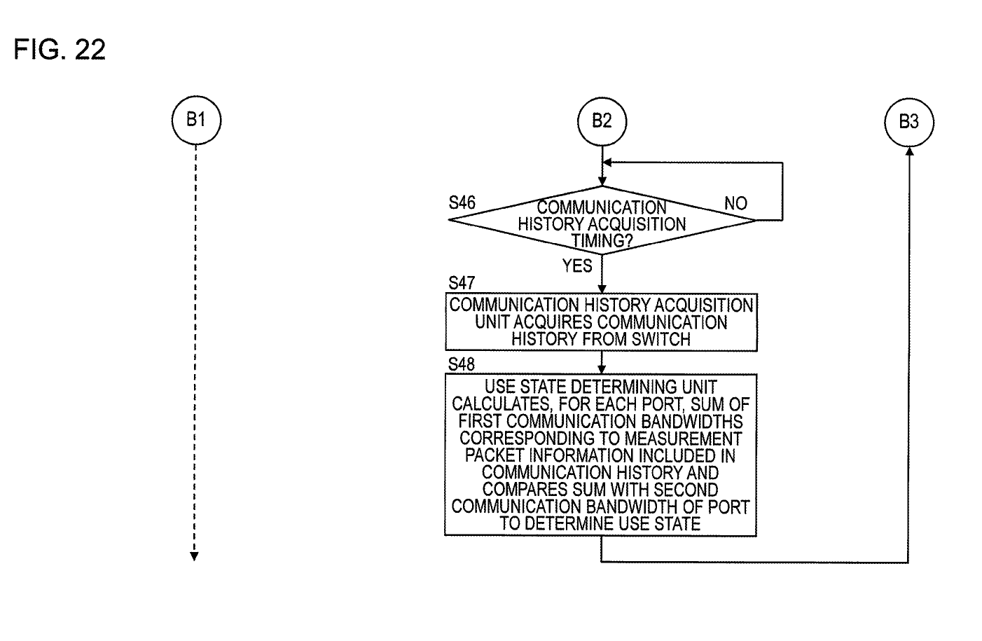

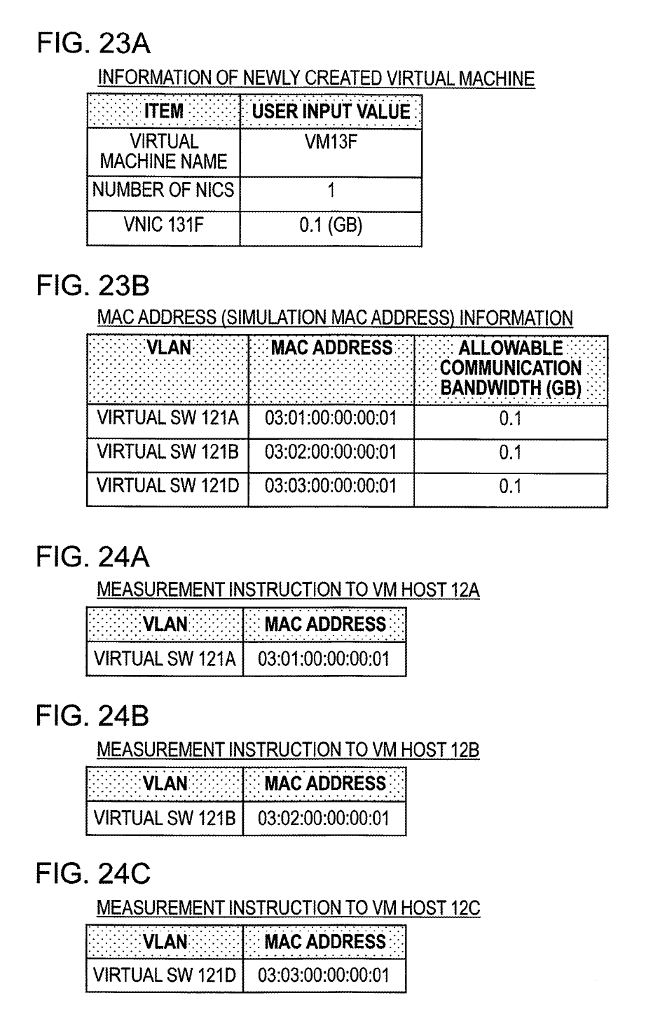

Next, a second embodiment will be described. FIGS. 21 and 22 are flowcharts for describing the network management process according to the second embodiment. Moreover, FIGS. 23A and 23B to FIG. 27 are diagrams for describing the network management process according to the second embodiment. The network management process of FIGS. 21 and 22 will be described with reference to FIGS. 23A and 23B to FIG. 27.

In the second embodiment, unlike the first embodiment, bottleneck occurred presently in a network is detected, and, in addition to this, bottleneck occurring when a new virtual machine is created is predicted in advance. That is, in the first embodiment, a communication bandwidth (hereinafter also referred to as a third communication bandwidth) only in which a virtual machine created in each VM host is allowed to perform communication is taken into consideration. In contrast, in the second embodiment, a communication bandwidth (hereinafter also referred to as a fourth communication bandwidth) in which a virtual machine that is scheduled to be created in each VM host is allowed to perform communication as well as the communication bandwidth in which a virtual machine created in each VM host is allowed to perform communication are taken into consideration. Hereinafter, the second embodiment will be described by appropriately referring to FIGS. 10 to 20 described in the first embodiment.

In the flowchart on the left side of FIG. 21, the communication bandwidth storage unit 118 of the management server 11 stores the virtual machine communication bandwidth information 133 and the physical switch communication bandwidth information 134 in the background of the network management process similarly to the first embodiment (S40).

Moreover, in the flowchart on the right side of FIG. 10, the configuration information receiving unit 116 performs standby until the configuration information receiving unit 116 receives the configuration information 136 (S41: NO). Then when the configuration information receiving unit 116 receives the configuration information 136 (S41: YES), for example, the MAC address setting unit 120 of the management server 11 sets the MAC address information 135 in which each of the created virtual machines is associated with the MAC address transmitted to each VM host. Further, the MAC address storage unit 121 of the management server 11 stores the MAC address information 135 set by the MAC address setting unit 120 (S42). The measurement instructing unit 119 of the management server 11 transmits a measurement instruction to respective VM hosts (S43). The content of processes of steps S40 to S43 is the same as that of steps S10 to S13 of the first embodiment, and detailed description thereof will not be provided.

Subsequently, the MAC address setting unit 120 sets the MAC address information 135 in which a virtual machine that is scheduled to be created is associated with an MAC address transmitted to each VM host, for example. Further, the MAC address storage unit 121 stores the MAC address information 135 set by the MAC address setting unit 120 (S44). In the following description, the MAC address information 135 for the created virtual machine is also referred to as observation MAC address information and the MAC address information or the virtual machine scheduled to be created is also referred to as simulation MAC address information. The MAC address storage unit 121 may store the observation MAC address and the simulation MAC address as different tables and may store the MAC addresses in the same table.

FIGS. 23A and 23B are examples of a case where a new virtual machine is created in the network illustrated in FIG. 14. Specifically, a case where a virtual machine 13F is created in any one of the VM hosts 12A, 12B, and 12C of FIG. 14 will be described. It is assumed that this virtual machine 13F includes one virtual NIC of which the allowable communication bandwidth is 0.1 (GB), as illustrated in FIG. 23A. The setting contents of the new virtual machine illustrated in FIG. 23A may be registered in the management server 11 by users, for example.

In the example of FIG. 23B, the MAC address setting unit 120 sets the simulation MAC address information 135 assuming that the virtual machine 13F that is scheduled to be created is created redundantly in a plurality of VM hosts (VM hosts 12A, 12B, and 12C). Specifically, in the example of FIG. 23B, for example, it is assumed that the virtual machine 13F is created in a VLAN to which the virtual switch 121A of the VM host 12A belongs, and the virtual machine 13F is created in a VLAN to which the virtual switch 121B of the VM host 12B belongs. Moreover, since presently, a virtual machine and a virtual switch are not present in the VM host 12C, it is assumed that the virtual switch 121D is present and that the virtual machine 13F is created in a VLAN to which the virtual switch 121D belongs. Moreover, the MAC address setting unit 120 sets the MAC addresses “03:01:00:00:00:01”, “03:02:00:00:00:02”, and “03:03:00:00:00:03” so as to be associated with respective VLANs. Moreover, the MAC address setting unit 120 sets 0.1 (GB) as the allowable communication bandwidth in association with respective VLANs. When candidate VM hosts in which the virtual machine 13F is to be created are narrowed down in advance, the simulation MAC address information 135 may be set by assuming that the virtual machine 13F is created in the candidate VM hosts only. That is, in the example of FIGS. 23A and 23B, the simulation MAC address information 135 may be set assuming that the virtual machine 13F is created in the VM host 12B only, for example.

Moreover, the MAC address setting unit 120 sets different MAC addresses which are the observation MAC address information 135 and the simulation MAC address information 135 with respect to the same VLAN. Specifically, in FIG. 16B, the MAC address setting unit 120 sets “a1:00:00:00:00:01” as the MAC address of a VLAN to which the virtual switch 121A belongs. In contrast, in FIG. 23B, the MAC address setting unit 120 sets “03:01:00:00:00:01” as the MAC address of a VLAN to which the virtual switch 121A belongs. In this way, the use state determining unit 123 can distinguish between the communication history of a virtual machine that has been created and the communication history of a virtual machine that is scheduled to be created.

Returning to FIG. 21, the measurement instructing unit 119 transmits a measurement instruction to respective VM hosts to instruct the VM hosts to broadcast a measurement packet of which the transmission source is the MAC address included in the measurement instruction (S45).

FIGS. 24A to 24C are examples of the measurement instruction in the example of FIG. 14. In the examples of FIGS. 24A to 24C, the corresponding MAC address is transmitted to a VM host that includes the respective VLANs stored in the simulation MAC address information 135 in FIG. 23B. The measurement instruction in the examples of FIGS. 24A to 24C includes a VLAN name and an MAC address. Specifically, the measurement instruction in FIG. 24A is transmitted to the VM host 12A that includes a VLAN to which the virtual SW 121A belongs, the measurement instruction in FIG. 24B is transmitted to the VM host 12B that includes a VLAN to which the virtual SW 121B belongs, and the measurement instruction in FIG. 24C is transmitted to the VM host 12D that includes a VLAN to which the virtual SW 121D belongs. The details of the measurement instruction have been described in FIGS. 17A and 17B, and detailed description thereof will not be provided.

Returning to FIG. 22, the communication history acquisition unit 122 performs standby until the communication history acquisition unit 122 acquires the communication history from respective physical switches (S46: NO). Then, the communication history acquisition unit 122 acquires the communication history from respective physical switches (S47) at the point in time of acquiring the communication history from the respective physical switches (S46: YES).

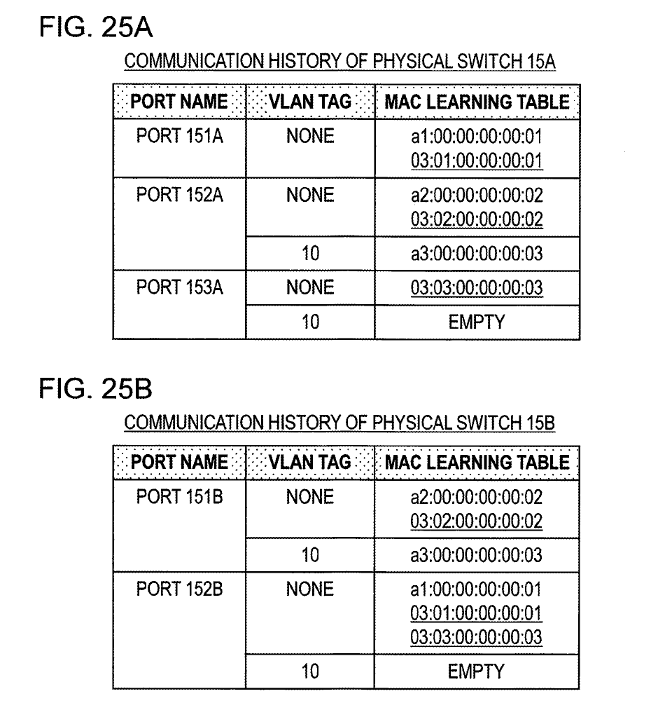

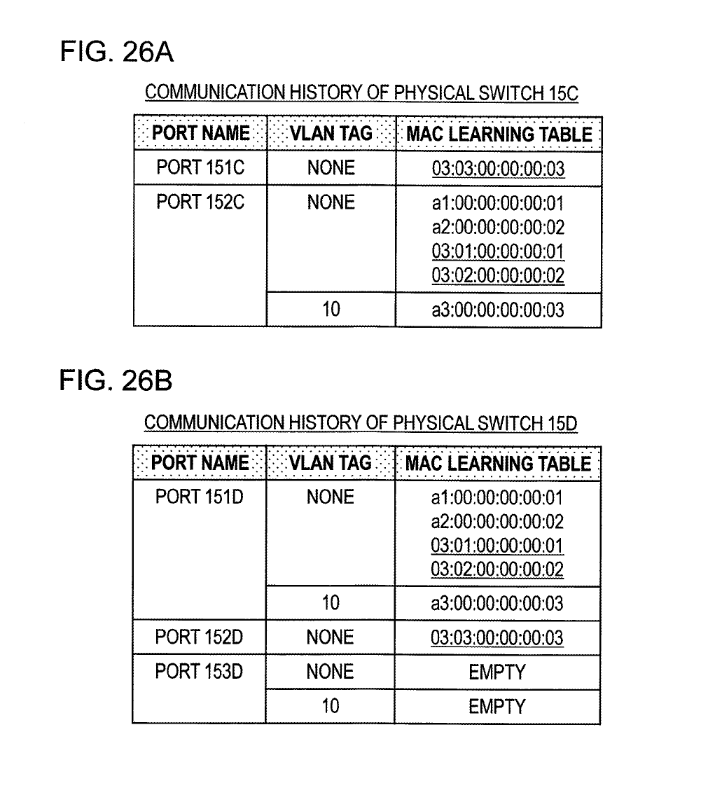

FIGS. 25A and 25B and FIGS. 26A and 26B are examples of the communication history in the example of FIG. 14. The communication history in FIGS. 25A and 25B and FIGS. 26A and 26B has the same items as the communication history of FIGS. 18A and 18B and FIGS. 19A and 19B.

Specifically, in the example of FIG. 14, a measurement packet (hereinafter referred to as a measurement packet D) which is transmitted by the VM host 12A and which corresponds to the measurement instruction of FIG. 24A is transmitted to the port 151A of the physical switch 15A via the physical NIC 122A of the VM host 12A. Due to this, as illustrated in FIG. 25A, an MAC address “03:01:00:00:00:01” is stored in the MAC learning table to which no tag is appended, of the port 151A of the physical switch 15A. Subsequently, the measurement packet D is transmitted to the port 152B of the physical switch 15B via the port 152A of the physical switch 15A. Moreover, the measurement packet D is transmitted to the port 151D of the physical switch 15D via the port 153A of the physical switch 15A. Further, the measurement packet D is transmitted to the port 152C of the physical switch 15C via the port 152D of the physical switch 15D. Due to this, as illustrated in FIG. 25B, an MAC address “03:01:00:00:00:01” is stored in the MAC learning table to which no tag is appended, of the port 152B of the physical switch 15B. Moreover, as illustrated in FIGS. 26A and 26B, a MAC address “03:01:00:00:00:01” is stored in the MAC learning table to which no tag is appended, of the port 152C of the physical switch 15C and the MAC learning table to which no tag is appended to the port 151D of the physical switch 15D.

Subsequently, a measurement packet (hereinafter referred to as a measurement packet E) which is transmitted from the VM host 12B and which corresponds to the measurement instruction of FIG. 24B is transmitted first to the port 151B of the physical switch 15B via the physical NIC 122B of the VM host 12B. Due to this, as illustrated in FIG. 25B, an MAC address “03:02:00:00:00:02” is stored in the MAC learning table to which no tag is appended, of the port 151B of the physical switch 15B. Moreover, the measurement packet E is transmitted to the port 152A of the physical switch 15A via the port 152B of the physical switch 15B. Further, the measurement packet E is transmitted to the port 151D of the physical switch 15D via the port 153A of the physical switch 15A. Further, the measurement packet E is transmitted to the port 152C of the physical switch 15C via the port 152D of the physical switch 15D. Due to this, as illustrated in FIG. 25A, an MAC address “03:02:00:00:00:02” is stored in the MAC learning table to which no tag is appended, of the port 152A of the physical switch 15A. Moreover, as illustrated in FIGS. 26A and 26B, an MAC address “03:02:00:00:00:02” is stored in the MAC learning table to which no tag is appended, of the port 152C of the physical switch 15C and the MAC learning table to which no tag is appended, of the port 151D of the physical switch 15D.

Moreover, a measurement packet (hereinafter referred to as a measurement packet F) which is transmitted to the VM host 12C and which corresponds to the measurement instruction of FIG. 24C is transmitted to the port 151C of the physical switch 15C via the physical NIC 122C of the VM host 12C. Due to this, as illustrated in FIG. 26A, an MAC address “03:03:00:00:00:03” is stored in the MAC learning table to which no tag is appended, of the port 151C of the physical switch 15C. Subsequently, the measurement packet F is transmitted to the port 152D of the physical switch 15D via the port 152C of the physical switch 15C. Due to this, as illustrated in FIG. 26B, an MAC address “03:03:00:00:00:03” is stored in the MAC learning table to which no tag is appended, of the port 152D of the physical switch 15D. Further, the measurement packet F is transmitted to the port 153A of the physical switch 15A via the port 151D of the physical switch 15D. Moreover, the measurement packet F is transmitted to the port 152B of the physical switch 15B via the port 152A of the physical switch 15A. Due to this, as illustrated in FIGS. 25A and 25B, an MAC address “03:03:00:00:00:03” is stored in the MAC learning table to which no tag is appended, of the port 153A of the physical switch 15A and the MAC learning table to which no tag is appended, of the port 152B of the physical switch 15B.

Returning to FIG. 22, the use state determining unit 123 of the management server 11 calculates the sum of the virtual machine communication bandwidth information 133 corresponding to the MAC addresses included in the communication history for respective ports and compares the sum with the physical switch communication bandwidth information 134 of the port to thereby determine the use state of the respective physical switches (S48). In the example described in FIGS. 23A and 23B to FIGS. 26A and 26B, a case where it is assumed that the virtual machine 13F that is scheduled to be created is created redundantly in the VM hosts 12A, 12B, and 12C has been described. Here, actually, the virtual machine 13F is created in one VM host only. Due to this, the use state determining unit 123 needs to eliminate the redundant information in the communication history of the virtual machine 13F when determining the use state of the physical switch (for example, when calculating the sum of the communication bandwidths).

That is, the use state determining unit 123 calculates the sum (hereinafter also referred to a first sum) of the third communication bandwidths (communication bandwidths in which virtual machines that have been created are allowed to perform communication) corresponding to the measurement packets included in the communication history for respective ports. Moreover, the use state determining unit 123 calculates the sum (hereinafter also referred to as a second sum) of fourth communication bandwidths (communication bandwidths in which virtual machines that are scheduled to be created are allowed to perform communication) which do not overlap for respective virtual machines (or for respective VLANs that include the virtual machines scheduled to be created) that are scheduled to be created, among the communication bandwidths corresponding to the measurement packets included in the communication history for respective ports. Further, the sum of the first and second sums is compared with the physical switch communication bandwidth information 134 of the port to thereby determine the use state of the respective physical switches.

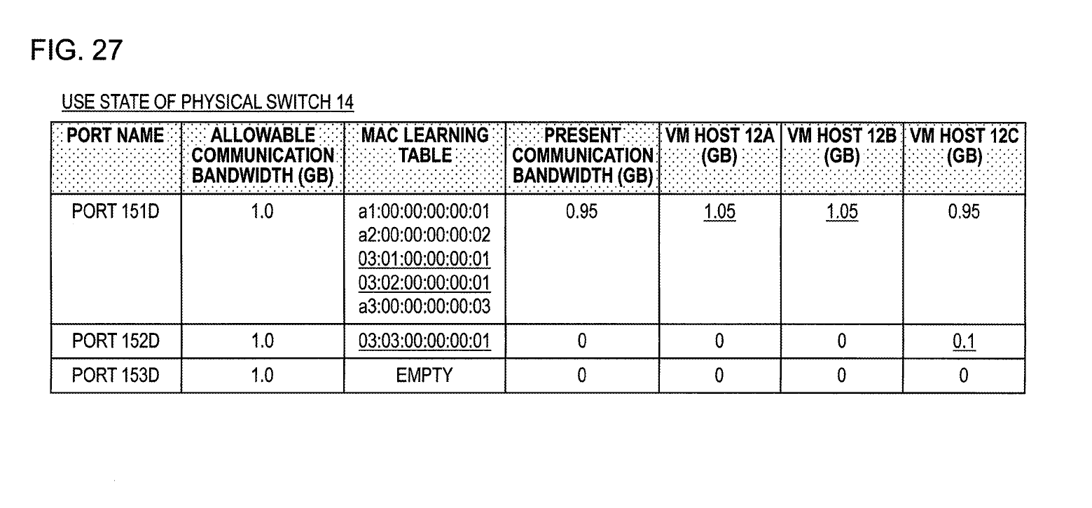

FIG. 27 is an example of a case of determining the use state in the example of FIG. 14. In the example of FIG. 27, a case where the use state of the physical switch 15D is determined will be described.

First, the use state determining unit 123 calculates the sum of allowable communication bandwidths of virtual machines that have been created by referring to the observation MAC address information 135 of FIG. 16B. Specifically, MAC addresses “a1:00:00:00:00:01”, “a2:00:00:00:00:02”, “a3:00:00:00:00:03”, “03:01:00:00:00:01”, and “03:02:00:00:00:02” are stored in the communication history of the port 151D of the physical switch 15D, received by the management server 1 as illustrated in FIG. 26B. Moreover, an MAC address “03:02:00:00:00:03” is stored for the port 152D. Among these MAC addresses, MAC addresses “a1:00:00:00:00:01”, “a2:00:00:00:00:02”, and “a3:00:00:00:00:03” correspond to virtual machines that have been created. Moreover, according to the MAC address information 135 of FIG. 23B, the communication bandwidths (third communication bandwidths) corresponding to the MAC addresses “a1:00:00:00:00:01”, “a2:00:00:00:00:02”, and “a3:00:00:00:00:03” are 0.45 (GB), 0.2 (GB), and 0.3 (GB), respectively. Thus, the sum of the allowable communication bandwidths of the virtual machines that have been created is 0.95 (GB) similarly to the first embodiment.

Subsequently, the use state determining unit 123 calculates the sum of allowable communication bandwidths of the port 151D when the virtual machine 13F is created redundantly in the VM hosts 12A, 12B, and 12C.

In FIG. 27, the sum of allowable communication bandwidths of virtual machines that have been created is added to the allowable communication bandwidth corresponding to the MAC address “03:01:00:00:00:01” when it is assumed that the virtual machine 13F is created in the VM host 12A. Specifically, referring to FIG. 23B, the sum (0.95 (GB)) of allowable communication bandwidths of the virtual machines that have been created is added to the allowable communication bandwidth (0.1 (GB)) corresponding to the MAC address “03:01:00:00:00:01”. Moreover, the addition result (1.05 (GB)) is the sum of communication bandwidths needed for the port 151D when the virtual machine 13F is created in the VM host 12A. When the virtual machine 13F is created in the VM host 12A, the sum of communication bandwidths needed for the virtual machines at the ports 152D and 153D is 0 (GB).

That is, the information on the virtual machine 13F that is scheduled to be created is redundantly stored in the communication history acquired by the communication history acquisition unit 122. Due to this, when the sum of communication bandwidths needed for the virtual machines for respective ports is to be calculated, it is needed to calculate the sum so that the communication history of the virtual machine 13F does not overlap.

Subsequently, the use state determining unit 123 acquires the available communication bandwidth of the port 151D by referring to the physical switch communication bandwidth information 134 illustrated in FIG. 15B. Moreover, the calculated sum of allowable communication bandwidths of both the created virtual machines and the virtual machines scheduled to be created of the port 151D is compared with the available communication bandwidth of the port 151D. When the calculated sum of allowable communication bandwidths is smaller than the available communication bandwidth of the port 151D, the use state determining unit 123 determines that the use state of the port 151D is normal (bottleneck does not occur in the port 151D).

Specifically, in the example of FIG. 27, since the calculated sum of communication bandwidths of the port 151D needed by the virtual machine is 1.05 (GB), the sum exceeds the available communication bandwidth (1.0 (GB)) of the port 151D. Due to this, the use state determining unit 123 determines that the use state of the port 151D is abnormal. That is, the use state determining unit 123 determines that it is not possible to create the virtual machine 13F in the VM host 12A since bottleneck occurs in the port 151D of the physical switch 15D.

The use state determining unit 123 calculates the sum of allowable communication bandwidths of both the created virtual machines and the virtual machines scheduled to be created for the VM hosts 12B and 12C similarly to the VM host 12A. Specifically, the sum of communication bandwidths of the port 151D needed when the virtual machine 13F is created in the VM host 12B is 1.05 (GB). Moreover, the sum of communication bandwidths of the port 151D needed when the virtual machine 13F is created in the VM host 12C is 0.95 (GB). Due to this, when the virtual machine 13F is created in the VM host 12B, the calculated sum (1.05 (GB)) of the allowable communication bandwidths exceeds the available communication bandwidth (1.0 (GB)) of the port 151D. On the other hand, when the virtual machine 13F is created in the VM host 12C, the calculated sum (0.95 (GB)) of the allowable communication bandwidths is smaller than the available communication bandwidth (1.0 (GB)) of the port 151D. Thus, the use state determining unit 123 determines that it is not possible to create the virtual machine 13F in the VM host 12B since bottleneck occurs in the port 151D of the physical switch 15D. Moreover, the use state determining unit 123 determines that it is possible to create the virtual machine 13F in the VM host 12C. Moreover, when the virtual machine 13F is created in the VM host 12C, the sum of communication bandwidths needed for the virtual machines at the ports 152D and 153D is 0 (GB) or 0.1 (GB). Due to this, when the virtual machine 13F is created in the VM host 12B or the VM host 12C, bottleneck does not occur in the ports 152D and 153D.

As described above, according to the second embodiment, the measurement instructing unit 119 instructs to the respective VM hosts to broadcast the measurement packet associated with the virtual machine scheduled to be created as well as the measurement packet associated with the virtual machine that has been created. Moreover, the use state determining unit 123 determines the use state of the physical switch based on the communication history of the measurement packet associated with the virtual machine scheduled to be created. In this way, when a new virtual machine is created, the management server 1 can predict the occurrence of bottleneck due to the new virtual machine created in advance.

In the example of FIG. 27, when there is a plurality of VM hosts capable of creating the virtual machine 13F, the use state determining unit 123 may select a VM host in which the sum of communication bandwidths needed for the virtual machines in respective physical switches is the smallest, for example.

Moreover, the use state determining unit 123 may preferentially select VM hosts in which all ratios (hereinafter also referred to as first ratios) of the available communication bandwidths of respective physical switches to the sum of communication bandwidths needed for the virtual machines of the physical switches are smaller than a threshold (hereinafter also referred to as a first threshold). That is, in this case, the use state determining unit 123 can obviate the occurrence of a physical switch (a physical switch in which bottleneck is highly likely to occur) on which load concentrates excessively.

Specifically, it is assumed that, when a new virtual machine 13F is created in the VM host 12A, the sum of communication bandwidths needed for the virtual machines in the physical switches 15A, 15B, 15C, and 15D is 1.8 (GB). Moreover, it is assumed that the largest one of the first ratios in the respective physical switches is 80%. On the other hand, it is assumed that, when a new virtual machine 13F is created in the VM host 12B, the sum of communication bandwidths needed for the virtual machines in the physical switches 15A, 15B, 15C, and 15D is 2.0 (GB). Moreover, it is assumed that the largest one of the first ratios in the respective physical switches is 50%. In this case, the sum of communication bandwidths needed for the virtual machines in respective physical switches decreases when the virtual machine 13F is created in the VM host 12A. However, for example, when the first threshold is 60%, the VM host 12B may be selected as the VM host in which the virtual machine 13F is created.

### Third Embodiment

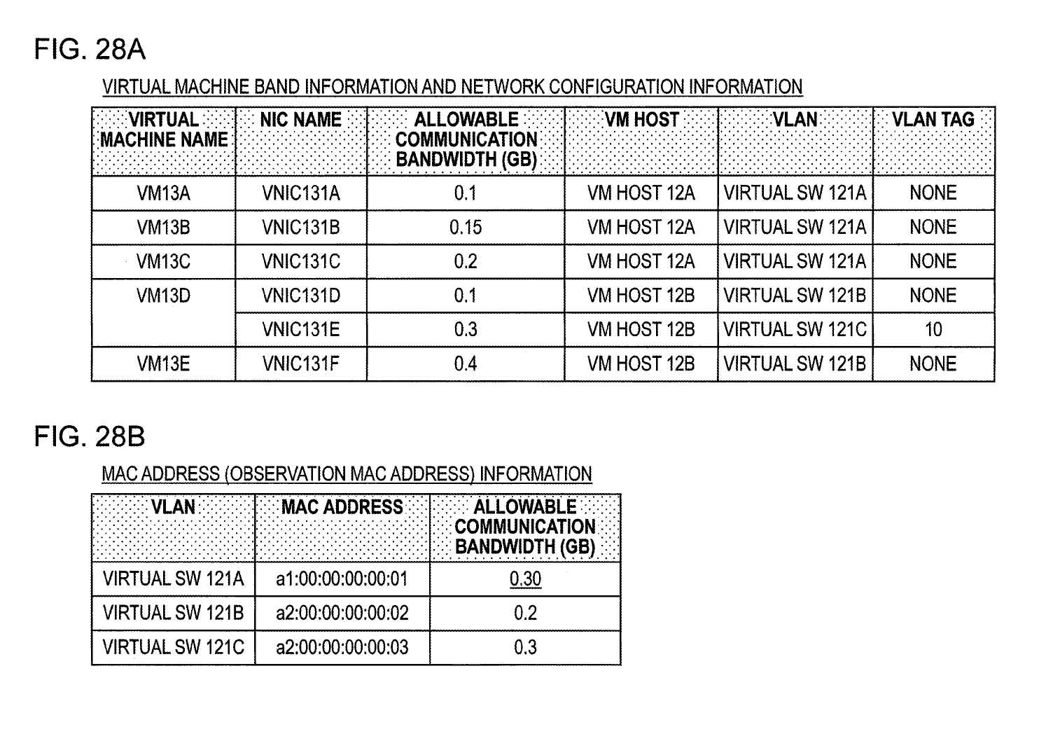

Next, a third embodiment will be described. FIGS. 28A and 28B are diagrams for describing the network management process according to the third embodiment.

In the third embodiment, when a virtual machine is removed, the use state of a network after the virtual machine is removed is determined.

FIG. 28A is an example of the virtual machine communication bandwidth information 133 and the configuration information 136 in the example of FIG. 14. Moreover, FIG. 28B is an example of the observation MAC address information 135 in the example of FIG. 14. In the example of FIG. 28A, the virtual machine 13B of the VM host 12A is removed. In this case, as illustrated in FIG. 28B, the MAC address setting unit 120 sets the MAC address information 135 by removing the allowable communication bandwidth of the removed virtual machine.

Specifically, the MAC address setting unit 120 sets an allowable communication bandwidth (0.3 (GB)) of the virtual NICs 131A and 131C excluding the virtual NIC 131B as the allowable communication bandwidth in the observation MAC address information 135 for a VLAN to which the virtual switch 121A belongs. In this way, the use state determining unit 123 can determine the use state of respective physical switches in a state where it is assumed that no packet is received from the removed virtual machine 13B.

Moreover, in the second embodiment, a case where a new virtual machine is simply created has been described. In contrast, a virtual machine may migrate from another VM host in the broadcast domain and a new virtual machine may be created. In this case, it is needed to predict the occurrence of bottleneck by taking communication of a virtual machine removed from a migration source VM host as well as communication of a virtual machine created in a migration destination VM host into consideration.

That is, when a virtual machine migrates, as described in the third embodiment, the MAC address setting unit 120 sets the observation MAC address information 135 by assuming that a migration target virtual machine is removed from a migration source VM host. Moreover, the use state determining unit 123 calculates the sum of communication bandwidths by removing the communication bandwidth of a migration target virtual machine in the migration source VM host and adding the communication bandwidth of the migration target virtual machine in the migration destination VM host. After that, the use state determining unit 123 determines the use state of the respective physical switches in the network. In this manner, the use state determining unit 123 can determine the use state even when a virtual machine migrates between VM hosts in the broadcast domain.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A management device that manages an information processing device that creates a virtual machine, comprising:
a storage unit that stores a first communication bandwidth in which the virtual machine is allowed to perform communication and a second communication bandwidth in which a port of a physical network device connected to the information processing device is allowed to perform communication;
an instructing unit that instructs the information processing device to broadcast a measurement packet associated with the virtual machine;
an acquisition unit that acquires communication history of the measurement packet in the port; and
a determining unit that determines a use state of the physical network device, based on the communication history, the first communication bandwidth, and the second communication bandwidth.

2. The management device according to claim 1, wherein
when the physical network device includes a plurality of ports, the acquisition unit acquires the communication history for each of the plurality of ports, and
the determining unit determines the use state for each of the plurality of ports.

3. The management device according to claim 1, wherein
the determining unit calculates a sum of the first communication bandwidth for the virtual machine corresponding to the measurement packet included in the communication history acquired by the acquisition unit for the port and compares the sum with the second communication bandwidth of the port, thereby determining the use state.

4. The management device according to claim 3, wherein
when the sum is smaller than the second communication bandwidth of the port, the determining unit determines that the use state is normal.

5. The management device according to claim 2, wherein
the first communication bandwidth includes a third communication bandwidth in which a virtual machine that has been created in the information processing device is allowed to perform communication.

6. The management device according to claim 2, wherein
the first communication bandwidth includes a third communication bandwidth in which a virtual machine that has been created in the information processing device is allowed to perform communication, and a fourth communication bandwidth in which a virtual machine that is scheduled to be created in the information processing device is allowed to perform communication when assumption is made that the virtual machine scheduled to be created is created.

7. The management device according to claim 6, wherein
when assumption is made that the virtual machine scheduled to be created is created redundantly in a plurality of information processing devices, the fourth communication bandwidth includes a communication bandwidth in which respective virtual machines are allowed to perform communication.

8. The management device according to claim 7, wherein
the determining unit calculates, for each of the ports, a sum of the third communication bandwidth for the virtual machine corresponding to the communication history acquired by the acquisition unit and a communication bandwidth which does not overlap for the respective virtual machines scheduled to be created from among the fourth communication bandwidths for the virtual machines corresponding to the communication history acquired by the acquisition unit, and compares the sum with the second communication bandwidth of the port, thereby determining the use state.

9. The management device according to claim 6, wherein
the virtual machine scheduled to be created includes a virtual machine which is created in the information processing device after migrating from another information processing device.

10. The management device according to claim 9, wherein
the determining unit calculate the sum by excluding the first communication bandwidth for the virtual machine scheduled to be created, in the other information processing device.

11. The management device according to claim 1, wherein
the instructing unit instructs the transmission of the measurement packet by transmitting a MAC address that is unique to a network that includes the information processing device, and
the instructing unit causes the information processing device to transmit a measurement packet, the source MAC address of which is the MAC address.

12. The management device according to claim 1, wherein
the instructing unit issues an instruction to transmit the measurement packet to each of VLANs to which the virtual machine belongs.

13. An information processing system comprising:
an information processing device that is capable of creating a virtual machine;
a management device that is connected to the information processing device so as to manage the information processing device; and
a physical network device that is connected to the information processing device and the management device, wherein
the management device includes:
a storage unit that stores a first communication bandwidth in which the virtual machine is allowed to perform communication and a second communication bandwidth in which a port of a physical network device connected to the information processing device is allowed to perform communication; and
an instructing unit that instructs the information processing device to broadcast a measurement packet associated with the virtual machine,
the information processing device includes a measurement packet transmitting unit that broadcasts the measurement packet in response to the instruction,
the physical network device includes:
a communication history storage unit that stores communication history of the measurement packet in the port, and the management device further includes an acquisition unit that acquires the communication history; and
a determining unit that determines a use state of the physical network device based on the communication history, the first communication bandwidth, and the second communication bandwidth.

14. A non-transitory computer-readable storage medium storing a management program for causing a computer to execute a process of managing an information processing device capable of creating a virtual machine, the process comprising:
storing a first communication bandwidth in which the virtual machine is allowed to perform communication and a second communication bandwidth in which a port of a physical network device connected to the information processing device is allowed to perform communication;
instructing the information processing device to broadcast a measurement packet associated with the virtual machine;
acquiring communication history of the measurement packet in the port; and
determining a use state of the physical network device, based on the communication history, the first communication bandwidth, and the second communication bandwidth.
